(19) United States
(12) Patent Application Publication
(10) Pub. No.: US 2006/0218074 A1
(43) Pub. Date: Sep. 28, 2006

(54) Automated trading platform

(76) Inventor: Wolf Kohn, Seattle, WA (US)

Correspondence Address: OLYMPIC PATENT WORKS PLLC, P.O. BOX 4277, SEATTLE, WA, 98104, US

(21) Appl. No.: 11/288,405

(22) Filed: Nov. 23, 2005

Related U.S. Application Data
(60) Provisional application No. 60/630,822, filed on Nov. 23, 2004.

(51) Int. Cl. G06Q 40/00

(52) U.S. Cl. 705/37

(57) ABSTRACT

Embodiments of the present invention include forecasting methods and systems and methods and systems for responding to forecasts. In one embodiment of the present invention, financial market trends are automatically forecast, allowing for automatic generation of specific market-transaction recommendations. An automated trading program embodiment of the present invention includes a short-term price forecaster and a controller that makes transaction recommendations.

### CROSS-REFERENCE TO RELATED APPLICATION

This application claims the benefit of Provisional Application No. 60/630,822, filed Nov. 23, 2004.

### COMPUTER PROGRAM LISTING APPENDIX

Two identical CDs identified as “Disk 1 of 2” and “Disk 2 of 2,” containing program source code implementing an embodiment of the present invention, are included as a computer program listing Appendix B. The program text can be viewed on a personal computer running a Microsoft Windows operating system, using Microsoft Notepad or other utilities used for viewing ASCII files.

### TECHNICAL FIELD

The present invention is related to forecasting, and, in particular, for forecasting financial market trends.

### SUMMARY OF THE INVENTION

Embodiments of the present invention include forecasting methods and systems and methods and systems for responding to forecasts. In one embodiment of the present invention, financial market trends are automatically forecast, allowing for automatic generation of specific market-transaction recommendations. An automated trading program embodiment of the present invention includes a short-term price forecaster and a controller that makes transaction recommendations.

### BRIEF DESCRIPTION OF THE DRAWINGS

FIG. 1 shows an architectural overview of the Automated Trading Plateform according to one embodiment of the present invention.

FIG. 2 shows a dynamic Price Trajectory according to one embodiment of the present invention.

FIG. 3 shows forecast engine internals according to one embodiment of the present invention.

FIG. 4 shows composition of a short-term price according to one embodiment of the present invention.

FIG. 5 shows an architecture for a continuous forecast engine according to one embodiment of the present invention.

FIG. 6 shows parallel operation of a parameter adaptation engine and a continuous forecast engine according to one embodiment of the present invention.

FIG. 7 illustrates sliding-window forecasting according to one embodiment of the present invention.

### DETAILED DESCRIPTION OF THE INVENTION

Introduction

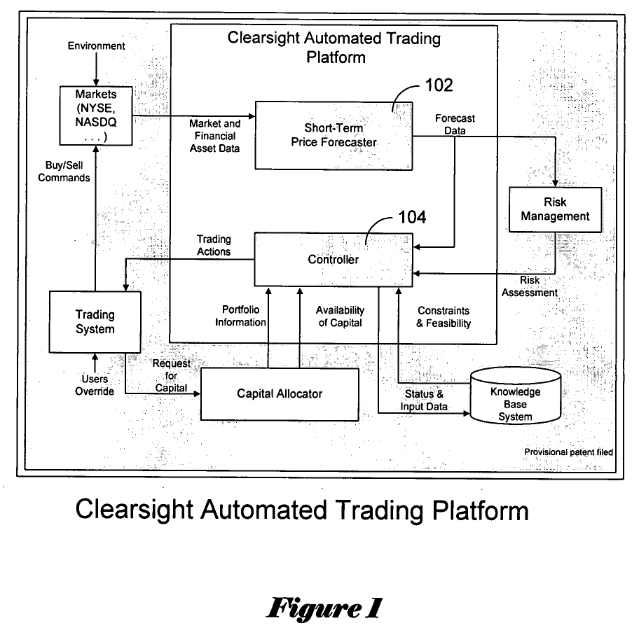

The Automated Trading Platform that represents one embodiment of the present invention implements a programmable financial forecasting and investing system designed to achieve pre-specified objectives for profit and risk by trading equities in a given portfolio. The platform is implemented through an architecture. A block diagram depicting the main components of this architecture and their connectivities is shown in FIG. 1.

The architecture of the trading platform is composed of two components, a Short-Term Price Forecaster 102 and a Controller 104, as illustrated in FIG. 1. The Short-Term Price Forecaster generates a time series of predicted security prices and their associated risk. Once security prices and risk are created the Controller develops recommendations for trading actions. These recommendations are reviewed and may be overridden by the user in forming buy and sell orders for the financial asset market. An implementation of one embodiment of the present invention is presented in this document.

Most problems involving the generation of actions in the financial environment are characterized by non-stationary uncertainty, non-negligible risk, and noisy, incomplete information. Embodiments of the present invention are based on the observation that financial decisions and forecasting processes are dynamical systems which can only be characterized, with acceptable level of accuracy, by fusing and synchronizing multiple models. Fusing and synchronizing models in this context means combining the extraction capabilities of specialized algorithms to produce an output with a lower level of uncertainty and better performance compared to results one would obtain by using individual models.

The basis of embodiments of the present invention is to model uncertainty using differential geometry. The concept starts with a stochastic differential equation and solves a piecewise diffusion equation with impulses. Unlike the Black-Scholes formula, we are not limited to the linear Gaussian case. Our internal model is based on a general predictor-corrector algorithm derived from the appropriate Chapman Kolmogorov propagation model 6.

Model Overview

Our system is based on a model for the dynamics of the portfolio, which is a piecewise diffusion process (PDP) [6]. We consider the price and risk of n stocks. We let the stochastic process x(t) be an n×1 vector for the price trajectory and u(t) be an m×1 vector for volume trajectory. In general, the dimensions of x(t) and u(t) are not the same. For instance, x(t) might be an 2n×1 vector for price and price rate trajectory and u(t) might be an n×1 vector for volume trajectory. However, one implementation treats m=n. We refer to x(t) as a price trajectory, and u(t) as a volume trajectory.

In one embodiment of the present invention, the Automated Trading Platform forecasts the price trajectory in the Short-Term Price Forecaster, and controls the volume trajectory in the Controller, based on the stochastic model in (1). The form of this model is bilinear in price x(t) and volume u(t), which reflects their interdependence and lack of causality. This stochastic model is the foundation of the Short-Term Price Forecaster and the Controller. In the Controller, we let the volume trajectory be impulses at times τₖ and characterize the stochastic process x(t) with the following PDP

$$ⅆ x ( t ) = ( {A}_{0} + {\sum }_{j = 1}^{p} {D}_{j} {f}_{j} ( t ) ) x ( t ) ⅆ t + Cf ( t ) ⅆ t + ϕ ( t ) ⅆ t + ⅆ ω ( t )$$

$$for {τ}_{k}^{+} \leq t \leq {τ}_{k + 1}^{-}$$

$$and$$

$$x ( {τ}_{k}^{+} ) = x ( {τ}_{k}^{-} ) + ( {\sum }_{i = 1}^{m} {A}_{i} {u}_{i} ( {τ}_{k} ) ) x ( {τ}_{k}^{-} ) + Bu ( {τ}_{k} )$$

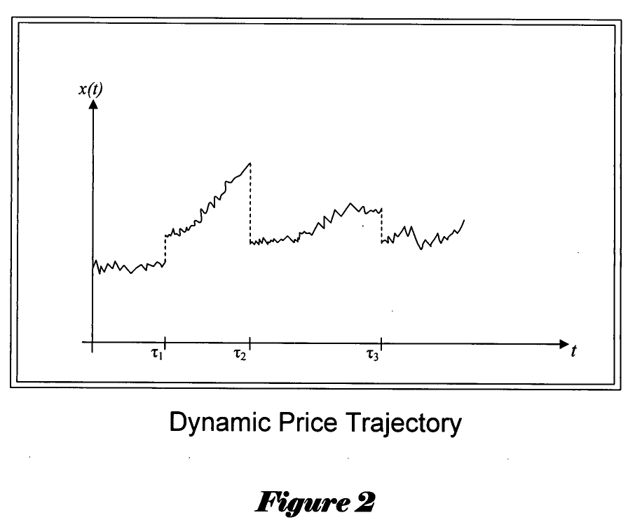

for an interval tε[t₀,t₁], with impulses at times τₖ. The i^{th} element of u(t) associated with stock i is denoted uᵢ(t). We assume that the impulse times τₖ are known, but in the future we may allow the impulse times to be Markov times. In our model 1, the volume u(τₖ) is an impulse control, and the price is not well-defined at τₖ, so we use the notation x(τₖ⁻) and x(τₖ⁺) to jump over the impulse time. A sample realization of a one-dimensional process x(t) with three impulses of volume is illustrated in FIG. 2.

The financial model given in (1) provides the ability to forecast and recommend trading decisions at the speed needed for an automated trading platform. The bilinear model with impulses in (1) mathematically accounts for jumps in the price x(t). The price jumps (as illustrated in FIG. 2) are not necessarily due to drastic changes in the market, but may be due to shifts in the frequencies, or spectral content, of the signals. The piecewise diffusion model in (1) does not assume that the market is a diffusion model, but rigorously models the discontinuities as impulses.

Empirical examination of market data supports the PDP model. Performing a Fast Fourier Transform (FFT) of the signal generates the underlying frequencies. The spectral analysis reveals discrete frequencies which support the PDP model with a diffusive component as well as a deterministic component. If the market were a pure diffusion process, the spectral analysis would generate a continuous spectrum of frequencies. This frequency analysis explains why the market does not behave as a Gaussian model—because it has discontinuities.

The difference between a PDP model as opposed to a Black-Scholes diffusion model is magnified when considering a real-time system with a sampling interval of 0.1 milliseconds. Consider the current system which is using 30 seconds between data updates. In the current system, a bid or ask order by one of the specialists of approximately one million shares will impact the market, and in 30 seconds, the price of the stock will reflect this large order. However a smaller order of one hundred shares in 30 seconds will have a negligible effect on the market. Now consider the future system with 0.1 milliseconds between data updates. In the future system, a bid or ask order of one hundred shares will impact the market (because the system is 10,000 times faster, so 10ˆ6/10ˆ4 would have a similar impact). The model that represents an embodiment of the present invention can appropriately account for these impulses, whereas a Black-Scholes model will artificially create volatility because of the incorrect assumption of a diffusion process.

Another consequence of the PDP model is the opportunity to take advantage of frequencies associated with a stock price. If we can predict the dominant frequency, then we not only recommend what to trade, but more importantly when to trade. For example, the model may recommend holding one stock for twice as long as another stock based on their frequency analyses. This implies that we should first predict the dominant frequency and then forecast the phase to utilize our model at another level.

The stochastic process ω(t), which drives the price variation x(t), represents uncertainty in our model, and is assumed to be a Semi-Martingale (6). This stochastic process ω(t) represents the inherent uncertainty due to the market environment and the accuracy of the model. We let φ(t) be an n×1 vector, representing the average value of the perturbation introduced by the market. The stochastic process ω(t) has zero mean, is of bounded quadratic variation, and has an n×n covariance matrix function Q(t). We assume that ω(t) is uncorrelated with x(t), i.e. E[x(t)ω(τ)]=0 for τ<t.

The piece-wise constant parameters of the model are A₀, Aᵢ, i=1, . . . ,m, Dⱼ, j=1, . . . ,p, B, and C. The n×n matrix A₀ defines a sales rate (also known as elasticity parameter in Leontief's model). The A₀ matrix is also called the relaxation matrix. The diagonal terms of A₀ establish the price trend of each stock, and the off-diagonal terms establish the relative advantage of one stock over another. The Aᵢ matrices are the effect of volume on price rate, and are n×n matrices which are multiplied by the i^{th} element of u(t), for I=1, . . . ,m. The Aᵢ matrices are called structure matrix coefficients because their product Aᵢuᵢ(t) modifies the price model. The rank of each matrix Aᵢ is one, and to simplify, we assume that the ii^{th} entry is the only nonzero entry. The term Aᵢuᵢ(t) captures the effect of the price rate due to demand, if uᵢ(t) is positive for stock i, then the price acceleration increases, and vice versa.

The Dⱼ matrices, for j=1, . . . ,p, are diagonal n×n matrices that characterize the effect of the market on rate price. For each aggregate market signal fⱼ(t), the product Dⱼfⱼ(t) represents the dynamics of the coordinate system of the market. This allows us to work in a principal coordinate system. The matrix B is an n×m diagonal matrix called the demand coefficient matrix, and C is an n×p coefficient matrix that measures the effect of the aggregate market on price rate. We use \hat{p}(t) to denote the collection of parameters (A₀, Aᵢ, i=1, . . . ,m, Dⱼ, j=1, . . . ,p, B, and C) of the model, with their current values at time t, as described in Section 3.5.

The characteristics of the market environment (for example, S&P500, Dow Jones, etc.) are included in f(t), a p×1 vector, and fⱼ(t) is the j^{th} element of f(t).

We manage the uncertainty due to parameter values and the uncertainty due to the market environment separately by employing two engines that interact (see Meditch [5], 1968 for a discussion on forced separation). In the Short-Term Price Forecaster, the Parameter Adaptation Engine addresses the uncertainty in the parameters, and the Continuous Forecast Engine captures the remaining uncertainty. We use the concept of a sliding window to continuously adapt and coordinate changes to price, volume, and parameters over short periods of time. The length of the sliding window is chosen so that the parameters are constant with respect to the model (1).

Real-time market and financial asset data are fed into the Short-Term Price Forecaster. The Short-Term Price Forecaster includes ask price x^{ask}, bid price x^{bid}, sell price x^{sell}, and volume u^{data}, for each stock, as well as market characteristics f^{data}. We use {Z(tₖ)} to denote the data observations that are collected at time instances tₖ that are not necessarily equally spaced. This data is filtered in the Asynchronous Filter Bank, and used to calculate continuous input series Z(t), which consists of the individual input series.

Short-Term Price Forecaster

Introduction

The Short-Term Price Forecaster is a real-time application for generating short-term forecast signals of price, risk, volume, and volatility for a user-selected portfolio. The input data is of two types: market data and asset data. The market data consists of user-selected indices (for example, DJIA, NASDAQ). In addition, the Short-Term Price Forecaster is supplied with asset data for each of the assets in the user's selected portfolio. The Short-Term Price Forecaster operates in sliding window mode and executes the repair strategy.

The concept of the repair strategy that is described here can adapt over short time periods when the price changes. The model is based on a propagator of the first moment conditioned on the filtration defined by the market data, and the second conditional moment that measures the volatility of the market. The model continuously repairs itself, as the system learns more accurate values of the model parameters. This repair strategy is crucial for periods of high volatility. The repair strategy begins by training the model with historical data to estimate the parameters. The dynamical model and the estimated parameters can then be used to solve for the price and risk trajectories. The time window advances and the data is updated. Then the parameters are estimated for the new time window. With each advance of the time window, the repair strategy continuously solves for the price and risk trajectories while updating the parameters in real-time.

The core of the Short-Term Price Forecaster is the Forecast Engine, which consists of three basic components: the Continuous Forecast Engine that estimates price and risk, the Parameter Adaptation Engine that estimates model parameters, and the Asynchronous Filter Bank that filters observations and produces continuous input streams. The uncertainty in the model is due to two reasons: uncertainty due to market environment and accuracy of the model, and uncertainty due to the parameter values. By using a separation principle, we can account for the two types of uncertainties separately in two coupled models. These coupled models can be executed in parallel with information exchange. The Parameter Adaptation Engine addresses the uncertainty due to parameter values and the Continuous Forecast Engine addresses the uncertainty due to market environment and accuracy. The sliding window concept with real-time data provides synchronization of the models, achieving our goal of predicting price and risk with a known level of uncertainty.

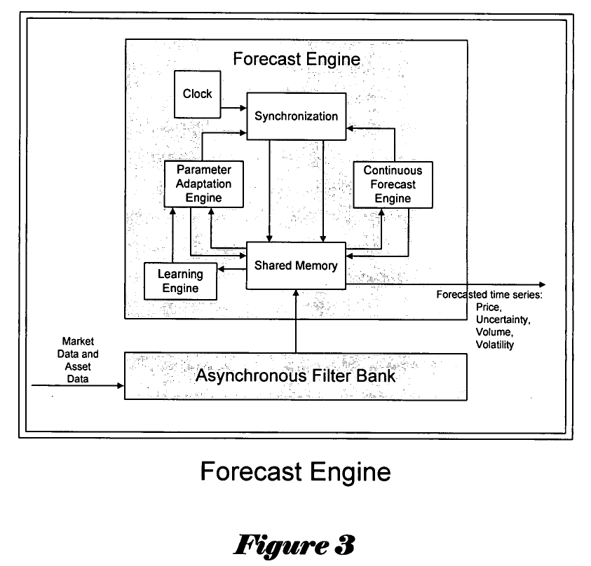

The overall system architecture of the Forecast Engine is shown in FIG. 3. The architecture consists of seven components: Continuous Forecast Engine (CFE), Parameter Adaptation Engine (PAE), Asynchronous Filter Bank (AFB), Learning Engine, Shared Memory System, Window Clock and Synchronization.

The Continuous Forecast Engine generates the nominal price \tilde{x}^{N}(t) and risk \tilde{Θ}^{N}(t) trajectories using a repair strategy while the Parameter Adaptation Engine updates the parameters \hat{p}(t) of the model. These parameters are stored in the Shared Memory System where, along with the computed input series and real-time data, they are available for the Continuous Forecast Engine to access at any moment. The Asynchronous Filter Bank filters the real-time data {Z(tₖ)} and produces the continuous input series Z(t) needed in the CFE. The Learning Engine is an algorithm that allows us to detect when the model in the Forecast Engine is drastically out of phase with respect to the current data and therefore a restart of the associated model is warranted. In this manner the Learning Engine acts as a meta-controller to the other modules in the Forecast Engine, detecting the need to regenerate the model paramaters and initiating the mechanism that does so. The Window Clock keeps track of the current time and the sliding window, and Synchronization handles all of the interactions between the Window Clock and the other components of the architecture.

We describe the functionality of the Continuous Forecast Engine in Section 3.4, the functionality of the Parameter Adaptation Engine in Section 3.5, the functionality of the Asynchronous Filter Bank in Section 3.3, the Learning Engine in Section 3.6, and the Lowpass Filter in Section 3.7.

Distributed Architecture

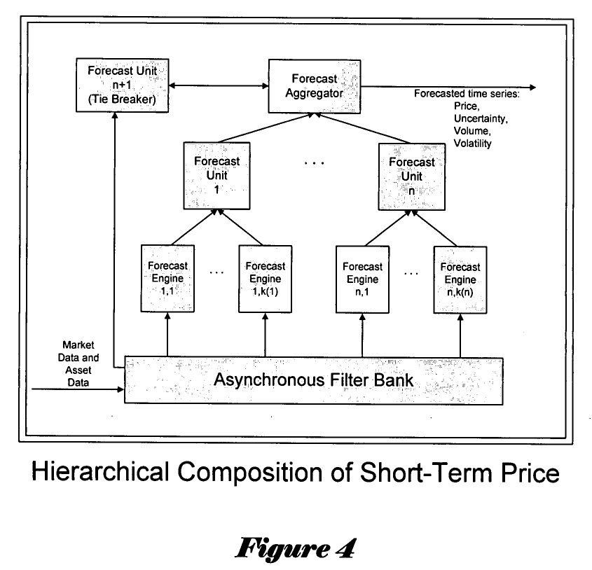

The computational algorithm of the Short-Term Price Forecaster is organized in a four-level hierarchical structure (see FIG. 4). In the lowest level, a proprietary Asynchronous Filter Bank transforms the asynchronous market and asset data into synchronous signals. The signal is next fed to a group of algorithms called Forecast Engines. Each one of these engines processes a subset of the portfolio and market data to generate a forecast. The composition of these subsets is determined by the user and by correlation information of the assets in the portfolio. For example, one such grouping can be a group of transportation-related assets in the NYSE.

The next level is composed of a set of Forecast Units that detect and correct incompatibilities in the forecasts from the Forecast Engines. This data fusion operation performed by the Forecast Units improves the overall quality of the forecast. At the highest level is aggregator software that implements a voting schema that allows the Forecaster to detect and discard erroneous forecasts in the subgroups of the portfolio. The voting schema significantly improves the reliability of the forecasts.

3.3 Asynchronous Filter Bank

The Asynchronous Filter Bank inputs are equity and market data. The data consists of the following items: ask price, bid price, sale price and volume for each equity and aggregated market data. Nominally, the data items should be available at uniform sample times. However, this is not the case in the real-time setting. One or more data items may be missing at a sample time. Alternatively, for a given data item, we may obtain more than one value at a sample time. The Asynchronous Filter Bank has been designed to handle these anomalies in the input data.

The filter operates on known statistics about the error rate in the data. The input data is transformed into a uniform time sequence of estimates of the original data with known statistics.

We use {Z(tₖ)} to denote the data observations that are collected at time instance tₖ. The output from the Asynchronous Filter Bank are uniformly spaced sequences, x^{ask}(t), x^{bid}(t), x^{sell}(t), u^{data}(t), and f^{data}(t). This data is used in the Continuous Forecast and Parameter Adaptation Engines. There are 4n+p streams of data. Each one of them is handled by a component of the Asynchronous Filter Bank.

The methodology of the Asynchronous Filter Bank is described in Hybrid Asynchronous Filter, by Kohn, Brayman and Cholewinski (Clearsight document). The Asynchronous Filter Bank propagates the estimate. A Lyaponov filter is used to produce x^{ask}(t), x^{bid}(t), x^{sell}(t), and f^{data}(t). If no data is available, the latest filtered data (corrected by the latest observations) is used to get boundary conditions for the next propagation and to tune the parameters of the Asynchronous Filter Bank. The volume u^{data}(t) is produced by accumulating the volume data over the uniformly spaced time intervals. If no volume data is available in a time interval, then u^{data}(t) is set to zero for that interval.

3.4 Continuous Forecast Engine

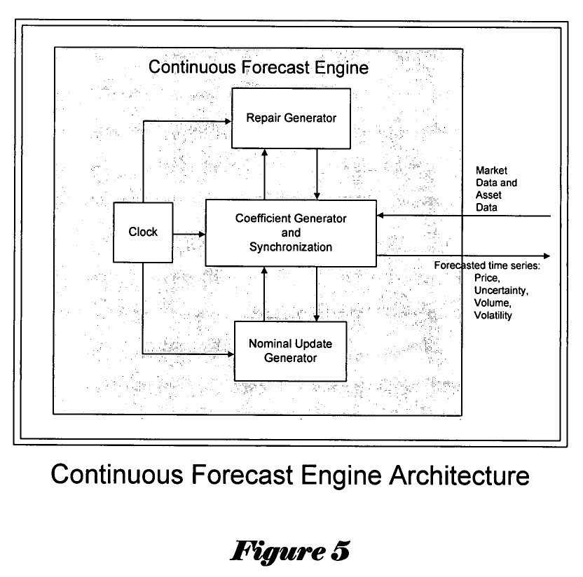

The primary role of the Continuous Forecast Engine is to generate the nominal price and risk trajectories using a repair strategy over a sliding time window. The architecture of the Continuous Forecast Engine takes advantage of the sliding window concept. It takes a nominal trajectory, extends it and computes a repair action, and then creates a new nominal trajectory. The Continuous Forecast Engine architecture, shown in FIG. 5, consists of three components, the Repair Generator, the Coefficient Generator & Synchronization (CG&S) module, and the Nominal Update Generator. The Nominal Update Generator computes nominal price and risk trajectories over an extended time window using the current estimate for the model parameters. The Repair Generator uses current model parameters and nominal trajectories to provide optimal repair price and risk trajectories over the advanced time window. The CG&S module computes nominal price and risk trajectories in the same time window using the trajectories provided by the Nominal Update Generator and the Repair Generator. The CG&S module also processes the new data as it becomes available, computes coefficients needed in the Repair Generator, and synchronizes with the Window Clock to coordinate the sliding window.

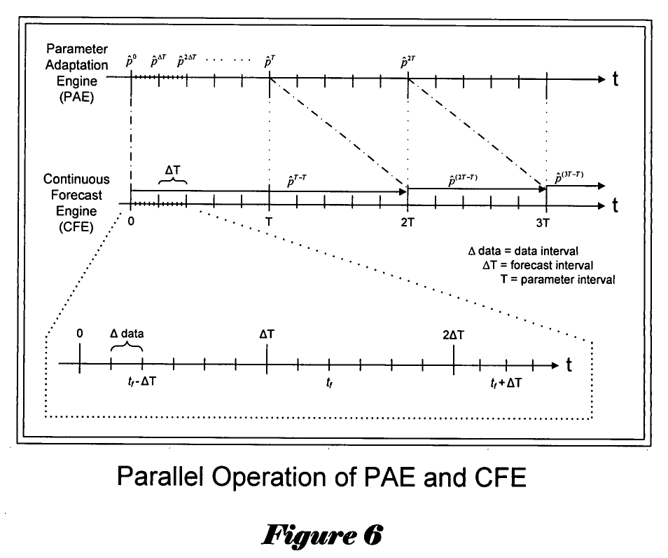

The Continuous Forecast Engine involves a sequence of steps over a time window, which are coordinated with the operations of the Parameter Adaptation Engine. The terminology of this sequencing in the Continuous Forecast Engine and the Parameter Adaptation Engine is illustrated in FIG. 6.

The CFE starts at the current time t_{f}, with an initial forecast window [t_{f}⁺, (t_{f}+ΔT)⁻] where t_{f}⁺ denotes the left side of the interval, and ΔT is the interval length. We use ΔT to denote the time horizon for forecasts; in the current example, ΔT is six seconds. We also consider the repair window, [(t_{f}−ΔT)⁺,t_{f}⁻], with a nominal trajectory for price and risk. The time interval between data points is Δ_{data}; in this example, Δ_{data} is one second. When the steps of the CFE are repeated, then the sliding window is updated from [t_{f}⁺,(t_{f}+ΔT)⁻] to [(t_{f}+Δ_{data})⁺,(t_{f}+Δ_{data}+ΔT)⁻]. Then we slide the window, or “kiss” the data h times during the time window. We let h be such that T=hΔT. Our approximate price is good up to the h order. We use T to denote the time between updates of the parameters, \hat{p}(t). In the current example, T is 30 seconds. The following steps in CFE describe the repair strategy over a sliding window. A summary of the steps with the equations are given in Section 3.4.7.

Step 0. Initialize window clock t, current time t_{f}, time increment ΔT, the time increment for the data Δ_{data}, and h such that ΔT=hΔ_{data}. Also, initialize a few matrices. Assume that nominal trajectories, parameters, and other previously computed input series are available.

Step 1. The CG&S reads the parameters \hat{p}(t) at t=t_{f} from the Parameter Adaptation Engine, and determines if the parameters have changed from the previous iteration. It sets the time window for the Repair Generator, i.e., [(t_{f}−ΔT)⁺,t_{f}⁻]. The CG&S module also reads the filtered data (x^{ask}(t), x^{bid}(t), x^{sell}(t), u^{data}(t), and f^{data}(t)) at the necessary times from the Asynchronous Filter Bank. Then the CG&S module computes input series and coefficients (e.g. ũ^{N}(t), f^{N}(t), φ^{N}(t), etc.) needed for the Repair Generator and the Nominal Update Generator.

Step 2. The Repair Generator solves the repair optimization model for the repair state y(t), the incremental risk Ω(t), and the repair action v(t) in the time window [(t_{f}−ΔT)⁺,t_{f}⁻]. Update the new nominal trajectories in the repair window [(t_{f}−ΔT)⁺,t_{f}⁻] by adding the repair trajectories to the old nominal trajectories.

Step 3. The CG&S module uses the repaired trajectories to provide initial conditions at t_{f}⁺ for price \tilde{x}^{N}(t) and risk evolution Θˆ{N}(t).

Step 4. The Nominal Update Generator solves for the nominal price \tilde{x}^{N}(t) and risk Θˆ{N}(t) trajectories in the forecast time window [t_{f}⁺,(t_{f}+ΔT)⁻]. Output \tilde{x}ᵢ^{N}(t_{f}+ΔT) and \sqrt{\tilde{Θ}ᵢᵢ^{N}(t_{f}+ΔT)} for i=1, . . . , n, and save trajectories for PAE.

Step 5. Update the sliding window and related trajectories:
t_{f}+t_{f}+Δ_{data}
and go to Step 1.
3.4.1 Time Window Updates

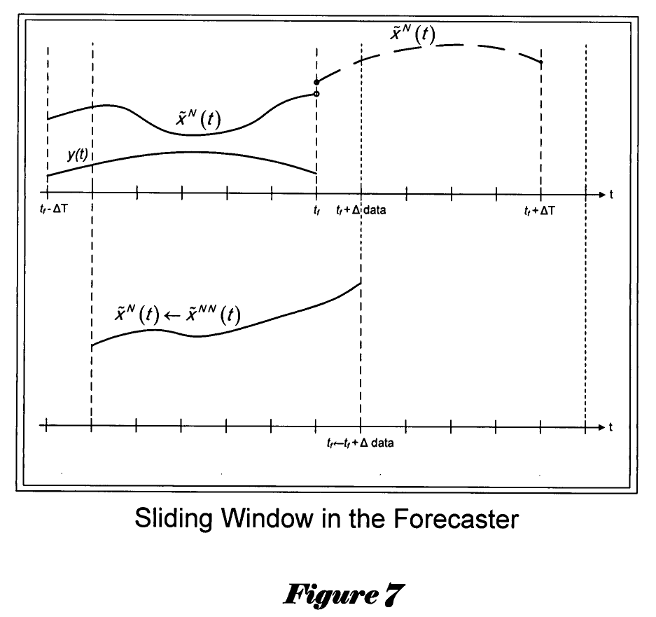

The price evolution and risk models for incremental and nominal modes are integrated into a scheme referred to as a sliding window. This strategy assumes that the decisions at the current time depend on finite interval (of duration Δ_{data}) histories of the evolution updates, and these intervals “slide” at a constant rate collecting present data (e.g. demand, uncertainty) and discarding the segments of the evolution in the past with respect to the current time. FIG. 7 illustrates the sliding window and the sequence of steps in the Continuous Forecast Engine.

The Window Clock maintains the forecast time window as [t_{f}⁺,(t_{f}+ΔT)⁻] and the repair window as [(t_{f}−ΔT)⁺,t_{f}⁻], where t_{f} is current time. With the initial condition being the last point of the updated evolution trajectories, the Nominal Update Generator computes an optimal extension of the nominal trajectories for the forecast interval [t_{f}⁺,(t_{f}+ΔT)⁻]. The Coefficient Generator and Synchronization module, and the Repair Generator (in Steps 3 and 4) update the coefficients and compute the repair evolution trajectories over the forecast interval as a function of the parameters computed using the nominal evolution trajectory. The criterion for this optimization is a functional that encodes the desired behavior of the application, e.g. max profit. The forecasted price and risk at time t_{f}+ΔT may be output. Then the Window Clock advances the interval to [(t_{f}+Δ_{data})⁺,(t_{f}+Δ_{data}+ΔT)⁻], and updates the nominal trajectories.

3.4.2 Nominal Update Generator Model

The Nominal Update Generator Model computes the nominal price \tilde{x}^{N}(t) and risk \tilde{Θ}^{N}(t) trajectories in the forecast time window [t_{f}⁺,(t_{f}+ΔT)⁻]. The equations governing this computation are given in the following model.

Let \tilde{x}(t)εRⁿ, tε[t_{f}⁺,(t_{f}+ΔT)⁻], be an estimate of the price x(t) at time t. While \tilde{x}(t) is not defined at impulse time t_{f}, \tilde{x}(t) is defined for the whole interval [t_{f}⁺,(t_{f}+ΔT)⁻] so we can integrate (2) to get \tilde{x}(t) in that interval. It can be shown (see Appendix 4.2) that \tilde{x}(t) satisfies the following differential equation,

$$ⅆ \tilde{x} ( t ) = ( {A}_{0} + {\sum }_{i = 1}^{m} {A}_{i} {u}_{i} ( t ) + {\sum }_{j = 1}^{p} {D}_{j} {f}_{j} ( t ) ) \tilde{x} ( t ) ⅆ t + ( Bu ( t ) + Cf ( t ) + ϕ ( t ) ) ⅆ t + K ( t ) ( {x}^{obs} ( t ) - \tilde{x} ( t ) ) δ ( t - {t}_{f} ) ⅆ t$$

where
K(t)=\tilde{Θ}(t)R⁻¹
and δ(t−t_{f}) is the delta distribution satisfying

$${\int }_{- ∞}^{+ ∞} f ( t ) δ ( t - τ ) ⅆ t = f ( τ )$$

for any continuous function f(t). The third term on the third line of equation (2) is a correction term due to the observation of price at time t_{f}. We use x^{sell}(t) as our x^{obs}(t). The K(t) expression is referred to as the gain, where R is an n×n symmetric positive definite matrix representing the noise covariance matrix. The risk \tilde{Θ}(t) is discussed next.

The central second moment conditioned in the continuous input series z(t) based on the input data of x(t), \tilde{Θ}(t)εR^{n×n}, tε[t_{f}⁺,(t_{f}+ΔT)⁻], measures the risk and it can be shown (see Appendix ??) that it satisfies the following differential equation

$$ⅆ \tilde{Θ} ( t ) = ( {A}_{0} + {\sum }_{i = 1}^{m} {A}_{i} {u}_{i} ( t ) + {\sum }_{j = 1}^{p} {D}_{j} {f}_{j} ( t ) ) \tilde{Θ} ( t ) ⅆ t + \tilde{Θ} ( t ) {( {A}_{0} + {\sum }_{i = 1}^{m} {A}_{i} {u}_{i} ( t ) + {\sum }_{j = 1}^{p} {D}_{j} {f}_{j} ( t ) )}^{T} ⅆ t + ( Q ( t ) - \tilde{Θ} ( t ) {R}^{- 1} \tilde{Θ} ( t ) ) ⅆ t .$$

Equation (3) propagates the parameters of the uncertainty ellipsoid \tilde{Θ}(t) that models the risk as a function of exogenous uncertainty at time t. In equation (3), Q(t) defines the uncertainty ellipsoid and R is the same symmetric positive definite matrix involved in (2).
The Nominal Update Generator uses x and \tilde{Θ} models (2) and (3) to create our nominal prediction over the forecast window. We use the superscript N to denote the nominal trajectories \tilde{x}^{N}(t) and \tilde{Θ}^{N}(t) for tε[t_{f}⁺,(t_{f}+ΔT)⁻]. We use the Parameter Adaptation Engine to estimate the parameters A₀, Aᵢ, i=1, . . . ,m, Dⱼ, j=1, . . . ,p, B, and C. The nominal values f^{N}(t), φ^{N}(t), and Q^{N}(t) are computed from the data in the CG&S module (see Section 3.4.6). The initial conditions needed to compute \tilde{x}^{N}(t) and \tilde{Θ}^{N}(t) are provided from the Repair Generator and the repaired trajectories \tilde{x}^{NN}(t) and \tilde{Θ}^{NN}(t) for the repair window [(t_{f}−ΔT)⁻,t_{f}⁺]. We next describe how to identify the initial conditions. Then we specify the details for creating the nominal trajectories.

The initial condition of \tilde{x}(t) at time t_{f}⁺ needs to be corrected by our observed data at that time, x^{sell}(t_{f}). We assume this correction is an impulse. For the nominal prediction at forecasting time t_{f}⁺, assume u(t)=ũ^{N}(t_{f}) for tε[t_{f}⁺,(t_{f}+ΔT)⁻] (i.e., u(t) is a constant in the forecast time interval). We denote the initial conditions \tilde{x}^{IC} and \tilde{Θ}^{IC} as the values of \tilde{x}^{N}(t_{f}⁺) and \tilde{Θ}^{N}(t_{f}⁺) respectively. The initial conditions for \tilde{x}^{IC} include a correction term corresponding to the third line in equation (2) that includes the observed value x^{sell}(t_{f}). The initial conditions are updated as follows
\tilde{x}^{IC}=\tilde{x}^{NN}(t_{f}⁻)+\tilde{Θ}^{NN}(t_{f}⁻)R⁻¹(x^{sell}(t_{f})−\tilde{x}^{NN}(t_{f}⁻))
where \tilde{x}^{NN}(t_{f}⁻) and õ^{NN}(t_{f}⁻) are given by repair, and
\tilde{Θ}^{IC}=\tilde{Θ}^{NN}(t_{f}⁻)
The correction term −\tilde{Θ}R⁻¹\tilde{Θ} in (3) continuously updates \tilde{Θ} so that the initial conditions \tilde{Θ}^{IC} equal the repaired value \tilde{Θ}^{NN}(t_{f}⁻).

Now we forecast price and risk. We forecast price by integrating equation (2) where we use ũ^{N}(t_{f}), f^{N}(t_{f}), and φ^{N}(t) as constant values over the forecast window. The correction term in (2) has already been accounted for in the initial conditions (4) and is not needed in the integration. Thus we integrate the following differential equation to obtain the nominal price trajectory,

$$\frac{ⅆ {\tilde{x}}^{N} ( t )}{ⅆ t} = ( {A}_{0} + {\sum }_{i = 1}^{m} {A}_{i} {\tilde{u}}_{i}^{N} ( {t}_{f} ) + {\sum }_{j = 1}^{p} {D}_{j} {f}_{j}^{N} ( {t}_{f} ) ) {\tilde{x}}^{N} ( t ) + B {\tilde{u}}^{N} ( {t}_{f} ) + {Cf}^{N} ( {t}_{f} ) + {ϕ}^{N} ( {t}_{f} )$$

with initial conditions given in (4), and over t between t_{f}⁺ and (t_{f}+ΔT)⁻.

The risk trajectory is forecasted by integrating (3) with constant values for ũ^{N}(t_{f}), f^{N}(t_{f}), and Q^{N}(t_{f}), yielding the following differential equation,

$$\frac{ⅆ {\tilde{Θ}}^{N} ( t )}{ⅆ t} = ( {A}_{0} + {\sum }_{i = 1}^{m} {A}_{i} {\tilde{u}}_{i}^{N} ( {t}_{f} ) + {\sum }_{j = 1}^{p} {D}_{j} {f}_{j}^{N} ( {t}_{f} ) ) {\tilde{Θ}}^{N} ( t ) + {\tilde{Θ}}^{N} ( t ) {( {A}_{0} + {\sum }_{i = 1}^{m} {A}_{i} {\tilde{u}}_{i}^{N} ( {t}_{f} ) + {\sum }_{j = 1}^{p} {D}_{j} {f}_{j}^{N} ( {t}_{f} ) )}^{T} - {\tilde{Θ}}^{N} ( {t}_{f} ) {R}^{- 1} {\tilde{Θ}}^{N} ( {t}_{f} ) + {Q}^{N} ( {t}_{f} )$$

with initial conditions given in (5), and over t between t between t_{f}⁺ and (t_{f}+ΔT)⁻.

The initial conditions (4) and (5) are computed in Step 3 of the CFE, and the nominal trajectories are updated in Step 4 of the CFE.

3.4.3 Repair Generator Model

The repair model uses a singular perturbation to obtain an incremental variation of the price and risk evolution trajectories with respect to computed nominal trajectories:
\tilde{x}^{NN}(t)=\tilde{x}^{N}(t)+εy(t)
\tilde{Θ}^{NN}(t)=\tilde{Θ}^{N}(t)+εΩ(t)
ũ^{NN}(t)=ũ^{N}(t)+εv(t)
for tε[(t_{f}−ΔT)⁺,t_{f}⁻] where the NN superscript denotes the new nominal trajectory, and ε is the perturbation parameter determined by the window characteristic, ε=Δ_{data}/ΔT=1/h. From the Ekeland principle [11], for a window of width ΔT and increment Δ_{data} with no forgetting function, we know that

$$ɛ = \frac{{Δ}_{data}}{Δ T} .$$

In (8)-(10), y(t) is the price repair, Ω(t) is the incremental risk, and v(t) is the repair action.

We also use a singular perturbation for
f^{NN}(t)=f^{N}(t)+εg(t)
φ^{NN}(t)=φ^{N}(t)+εξ(t)
Q^{NN}(t)=Q^{N}(t)+εW(t).
where g(t) is the incremental force by the environment, ξ(t) is the uncertainty in the market, and W(t) is the incremental external uncertainty.

In the CG&S module, g(t) is approximated by taking the difference of real-time data at time t and at time t−Δ_{data}. We set f^{NN}(t)=f^{N}(t)=f^{data}(t) and f^{N}(t−Δ_{data})=f^{data}(t−Δ_{data}), yielding

$${g}^{N} ( t ) = \frac{{f}^{N} ( t ) - {f}^{N} ( t - {Δ}_{data} )}{ɛ} .$$

Similarly, ξ(t) is estimated using φ^{NN}(t)=φ^{N}(t) at time t and φ^{N}(t−Δ_{data}) at time t−Δ_{data}, yielding

$${ξ}^{N} ( t ) = \frac{{ϕ}^{N} ( t ) - {ϕ}^{N} ( t - {Δ}_{data} )}{ɛ} .$$

And the same for W(t),

$${W}^{N} ( t ) = \frac{{Q}^{N} ( t ) - {Q}^{N} ( t - {Δ}_{data} )}{ɛ} .$$

The data for f^{N}(t) comes directly from the filtered data,
f^{N}(t)=f^{data}(t).
We estimate φ^{N}(t), the average value of the perturbation introduced by the market, by using the available data, x^{sell}, u^{data}, and f^{data} in equation (6), yielding

$$\begin{matrix}{ϕ}^{N} ( t ) = ( {x}^{sell} ( t ) - {x}^{sell} ( t - {Δ}_{data} ) ) - \\ ( {A}_{0} + {\sum }_{i = 1}^{m} {A}_{i} {u}_{i}^{data} ( t ) + {\sum }_{j = 1}^{p} {D}_{j} {f}_{j}^{N} ( t ) ) {x}^{sell} ( t ) - \\ {Bu}^{data} ( t ) - {Cf}^{data} ( t ) .\end{matrix}$$

The estimate for the covariance matrix Qᵢⱼ^{N}(t), the last term in equation (7), is also estimated using available data, x^{ask}, x^{bid}, and coefficients α, ε_{Q}, and α_{Q}, yielding

$$\begin{matrix}{Q}_{ij}^{N} ( t ) = {ɛ}_{Q}^{2} + {max}_{σ ∈ [ t - Δ T , t ]} \{ \frac{1}{2} ( \sqrt{α} \vert {x}_{i}^{ask} ( σ ) - {x}_{i}^{bid} ( σ ) \vert + \\ {α}_{Q} ) ( \sqrt{α} \vert {x}_{j}^{ask} ( σ ) - {x}_{j}^{bid} ( σ ) \vert + {α}_{Q} ) \}\end{matrix}$$

$$for i , j = 1 , … , n .$$

To derive the differential equation for the price repair y(t), starting from (8), we have,

$$\frac{ⅆ ( {\tilde{x}}^{NN} ( t ) )}{ⅆ t} = \frac{ⅆ ( {\tilde{x}}^{N} ( t ) + ɛ y ( t ) )}{ⅆ t}$$

which we can expand using equation (2), and then dropping the terms of order ε², we get

$$\begin{matrix}\frac{ⅆ y ( t )}{ⅆ t} = \tilde{A} ( t ) y ( t ) + ( {\sum }_{i = 1}^{m} {A}_{i} {v}_{i} ( t ) + {\sum }_{j = 1}^{p} {D}_{j} {g}_{j}^{N} ( t ) ) {\tilde{x}}^{N} ( t ) + \\ Bv ( t ) + {Cg}^{N} ( t ) + {ξ}^{N} ( t )\end{matrix}$$

$$where$$

$$\tilde{A} ( t ) = ( {A}_{0} + {\sum }_{i = 1}^{m} {A}_{i} {\tilde{u}}_{i}^{N} ( t ) + {\sum }_{j = 1}^{p} {D}_{j} {f}_{j}^{N} ( t ) ) .$$

Because the control variable is v(t), we rewrite (14) to highlight its linear form,

$$\begin{matrix}\frac{ⅆ y ( t )}{ⅆ t} = \tilde{A} ( t ) y ( t ) + {\sum }_{i = 1}^{m} ( {A}_{i} {\tilde{x}}^{N} ( t ) ) {v}_{i} ( t ) + Bv ( t ) + \\ {\sum }_{j = 1}^{p} {D}_{j} {\tilde{x}}^{N} ( t ) {g}_{j}^{N} ( t ) + {Cg}^{N} ( t ) + {ξ}^{N} ( t ) .\end{matrix}$$

For notational and computational convenience, in addition to defining Ã(t), we also define \tilde{B}(t) to be an n×m matrix
\tilde{B}(t)=(Ã^{x}(t)+B)
where Ã^{x}(t) is an n×m matrix with the ith column of Ã^{x}(t), for i=1, . . . ,m, given by
Ãᵢ^{x}(t)=Aᵢ\tilde{x}^{N}(t).
And \tilde{C}(t) is an n×1 vector given by

$$\tilde{C} ( t ) = {\sum }_{j = 1}^{p} {g}_{j}^{N} ( t ) {D}_{j} {\tilde{x}}^{N} ( t ) + {Cg}^{N} ( t ) + {ξ}^{N} ( t ) .$$

The coefficients Ã(t), \tilde{B}(t), and \tilde{C}(t) are computed in Step 1 of the Continuous Forecast Engine by the CG&S module, where g^{N}(t) and ξ^{N}(t) are estimated from the data. Now we can rewrite the dynamics equation in (15) as

$$\frac{ⅆ y ( t )}{ⅆ t} = \tilde{A} ( t ) y ( t ) + \tilde{B} ( t ) v ( t ) + \tilde{C} ( t ) .$$

Similarly, from (9), we can expand

$$\frac{ⅆ ( {\tilde{Θ}}^{NN} ( t ) )}{ⅆ t} = \frac{ⅆ ( {\tilde{Θ}}^{N} ( t ) + ɛ Ω ( t ) )}{ⅆ t} ,$$

and using Equation (3) it can be shown that

$$\begin{matrix}\frac{ⅆ Ω ( t )}{ⅆ t} = ( {A}_{0} + {\sum }_{i = 1}^{m} {A}_{i} {\tilde{u}}_{i}^{N} ( t ) + {\sum }_{j = 1}^{p} {D}_{j} {f}_{j}^{N} ( t ) ) Ω ( t ) + \\ Ω ( t ) {( {A}_{0} + {\sum }_{i = 1}^{m} {A}_{i} {\tilde{u}}_{i}^{N} ( t ) + {\sum }_{j = 1}^{p} {D}_{j} {f}_{j}^{N} ( t ) )}^{T} - \\ {\tilde{Θ}}^{N} ( t ) {R}^{- 1} Ω ( t ) - Ω ( t ) {R}^{- 1} {\tilde{Θ}}^{N} ( t ) + \\ {\sum }_{i = 1}^{m} {A}_{i}^{T} {v}_{i} ( t ) {\tilde{Θ}}^{N} ( t ) + {\sum }_{i = 1}^{m} {A}_{i} {v}_{i} ( t ) {\tilde{Θ}}^{N} ( t ) + \\ {\sum }_{j = 1}^{p} {\tilde{Θ}}^{N} ( t ) {D}_{j}^{T} {g}_{j}^{N} ( t ) + {\sum }_{j = 1}^{p} {D}_{j} {\tilde{Θ}}^{N} ( t ) {g}_{j}^{N} ( t ) + {W}^{N} ( t ) .\end{matrix}$$

For notational and computational convenience, we define
\tilde{V}ᵢ(t)=\tilde{Θ}^{N}(t)Aᵢ^{T} for i=1, . . . ,m
and

$$\tilde{D} ( t ) = {\sum }_{j = 1}^{p} {\tilde{Θ}}^{N} ( t ) {D}_{j}^{T} {g}_{j}^{N} ( t ) + {\sum }_{j = 1}^{p} {D}_{j} {\tilde{Θ}}^{N} ( t ) {g}_{j}^{N} ( t ) + {W}^{N} ( t )$$

which are computed in Step 1 of the Continuous Forecast Engine. Using the notation for Ã(t), \tilde{V}ᵢ(t), we can rewrite (17) as

$$\begin{matrix}\frac{ⅆ Ω ( t )}{ⅆ t} = \tilde{A} ( t ) Ω ( t ) + Ω ( t ) {( \tilde{A} ( t ) )}^{T} - \\ {\tilde{Θ}}^{N} ( t ) {R}^{- 1} Ω ( t ) - Ω ( t ) {R}^{- 1} {\tilde{Θ}}^{N} ( t ) + \\ {\sum }_{i = 1}^{m} {\tilde{V}}_{i} ( t ) {v}_{i} ( t ) + {\sum }_{i = 1}^{m} {( {\tilde{V}}_{i} ( t ) )}^{T} {v}_{i} ( t ) + \tilde{D} ( t )\end{matrix}$$

Equations (15) and (17) constitute the model for the repair module. The control variable is v(t) which can be interpreted as a fictitious incremental volume caused by the uncertainty in the market and the accuracy of the model. Notice that the dynamics are functions of the control variable v(t), so we are controlling the uncertainty through v(t). The repair criterion in the following section completes the definition of the repair optimization model.
3.4.4 Repair Criteria

The repair criterion uses a least squares criterion for the estimated repair trajectories. It represents the user-defined running criterion rate (e.g. profit-risk combination).
The criterion for the Repair Generator is a functional of the form

$${J}^{R} ( v , s ) = {\int }_{{t}_{f} - Δ T}^{{t}_{f}} δ Π ( y ( t ) , Ω ( t ) , v ( t ) , t ) ⅆ t ,$$

where

$$\begin{matrix}δ Π ( y ( t ) , Ω ( t ) , v ( t ) , t ) = {( {\tilde{x}}^{N} ( t ) + ɛ y ( t ) - {x}^{sell} ( t ) )}^{T} S ( {\tilde{x}}^{N} ( t ) + \\ ɛ y ( t ) - {x}^{sell} ( t ) ) + ( diag ( {\tilde{Θ}}^{N} ( t ) + ɛ Ω ( t ) - \\ { {Θ}^{data} ( t ) ) )}^{T} {R}^{Ω} ( diag ( {\tilde{Θ}}^{N} ( t ) + ɛ Ω ( t ) - \\ {Θ}^{data} ( t ) ) ) + {( {\tilde{u}}^{N} ( t ) + ɛ v ( t ) - {u}^{data} ( t ) )}^{T} \\ M ( {\tilde{u}}^{N} ( t ) + ɛ v ( t ) - {u}^{data} ( t ) )\end{matrix}$$

and ε=Δ_{data}/ΔT=1/h, and S, R^{Ω}, and M are symmetric positive definite matrices where S and M have small positive values while R^{Ω} has large positive values to penalize the variance heavily. The notation diag (A) of an n×n matrix A used here is

$$diag ( A ) = [ \begin{matrix}{A}_{11} \\ {A}_{22} \\ ⋮ \\ {A}_{nn}\end{matrix} ]$$

and
Θᵢᵢ^{data}(t)=ε_{Q}²+(\sqrt{α}|xᵢ^{bid}(t)−xᵢ^{ask}(t)|+α_{Q})²
for each i=1, . . . , n.
3.4.5 Repair Optimization Problem

The repair optimization problem for the Repair Generator for each window update interval [t₁, t₂] is summarized here as

$${min}_{v} {\int }_{{t}_{1}}^{{t}_{2}} δ Π ( y ( t ) , Ω ( t ) , v ( t ) , t ) ⅆ t$$

$$subject to$$

$$\frac{ⅆ y ( t )}{ⅆ t} = \tilde{A} ( t ) y ( t ) + \tilde{B} ( t ) v ( t ) + \tilde{C} ( t )$$

$$as in ( ref \text{:} repair y 3 )$$

$$\begin{matrix}\frac{ⅆ Ω ( t )}{ⅆ t} = \tilde{A} ( t ) Ω ( t ) + Ω ( t ) {( \tilde{A} ( t ) )}^{T} - \\ {\tilde{Θ}}^{N} ( t ) {R}^{- 1} Ω ( t ) - Ω ( t ) {R}^{- 1} {\tilde{Θ}}^{N} ( t ) + \\ {\sum }_{i = 1}^{m} {\tilde{V}}_{i} ( t ) {v}_{i} ( t ) + {\sum }_{i = 1}^{m} {( {\tilde{V}}_{i} ( t ) )}^{T} {v}_{i} ( t ) + \tilde{D} ( t )\end{matrix}$$

$$as in ( ref \text{:} RepairOmega 2 )$$

where the repair criterion δπ(y(t), Ω(t), v(t), t) is given in (20). Initial conditions are given as y(t₁)=0 and Ω(t₁)=0.

Repair provides y(t), Ω(t), and v(t) for tε[(t_{f}−ΔT)⁺,t_{f}⁻].

3.4.6 Coefficient Generator and Synchronization

Coefficient Generator and Synchronization (CG&S) is involved in steps 1, 3 and 5 of the Continuous Forecast Engine. In general, CG&S reads the real-time data trajectories, and prepares the data and coefficients for use in the Repair Generator and in the Nominal Update Generator. CG&S also updates the information and synchronizes the computations with the sliding window.

In Step 1 of the CFE, the CG&S module reads the following data at time t=t_{f}: x^{ask}(t), x^{bid}(t), x^{sell}(t), u^{data}(t), f^{data}(t). The data is used to compute Q^{N}(t) for use in the Nominal Update Generator. Because the bid/ask prices give upper and lower bounds on market price (at time t), we can interpret them as the variance, standard deviation, or percentiles, on the average market price. The data is also used in the Repair Generator.

The data above is evaluated using values at t=t_{f} and held constant throughout the incremental window [t_{f}⁺,(t_{f}+ΔT)⁻].

The CG&S synchronizes with the Parameter Adaptation Engine to update parameters \hat{p}(t) at appropriate times, and holds these constant throughout the incremental window [t_{f}⁺,(t_{f}+ΔT)⁻].
In Step 3 of the CFE, the CG&S module computes the coefficients needed for the Repair Generator to solve the repair optimization model in the sliding time window [(t_{f}−ΔT+Δ_{data})⁺,(t_{f}+Δ_{data})⁻]. The coefficients computed are:

$$\tilde{A} ( t ) = ( {A}_{0} + {\sum }_{i = 1}^{m} {A}_{i} {\tilde{u}}_{i}^{N} ( t ) + {\sum }_{j = 1}^{p} {D}_{j} {f}_{j}^{N} ( t ) )$$

$${\tilde{A}}_{i}^{x} ( t ) = {A}_{i} {\tilde{x}}^{N} ( t ) for i = 1 , … , m$$

$$\tilde{B} ( t ) = ( {\tilde{A}}^{x} ( t ) + B )$$

$$\tilde{C} ( t ) = {\sum }_{j = 1}^{p} {g}_{j}^{N} ( t ) {D}_{j} {\tilde{x}}^{N} ( t ) + {Cg}^{N} ( t ) + {ξ}^{N} ( t ) . \\ {\tilde{Θ}}^{N} ( t ) {A}_{i}^{T} for i = 1 , … , m$$

$${A}_{i} {\tilde{Θ}}^{N} ( t ) for i = 1 , … , m$$

$${\tilde{Θ}}^{N} ( t ) {D}_{j}^{T} for j = 1 , … , p$$

$${D}_{j} {\tilde{Θ}}^{N} ( t ) for j = 1 , … , p$$

In Step 5 of the CFE, the CG&S module updates the new nominal trajectories in the sliding time window [(t_{f}−ΔT+Δ_{data})⁺,(t_{f}+Δ_{data})⁻]
\tilde{x}^{N}(t)←\tilde{x}^{N}(t)+εy(t)
\tilde{Θ}^{N}(t)←\tilde{Θ}^{N}(t)+εΩ(t)
ũ^{N}(t)←ũ^{N}(t)+εv(t)
where the Repair Generator provides y(t), Ω(t), and v(t).
3.4.7 Summary of the Continuous Forecast Engine
Here we summarize the steps in the Continuous Forecast Engine.

Step 0. Initialize window clock t, current time t_{f}, time interval for the forecast ΔT, the time increment for the filtered data Δ_{data}, and h such that ΔT=hΔ_{data}. Also, initialize S, R^{Ω}, and M, where S and R^{Ω} are diagonal n×n matrices and M is a diagonal m×m matrix, and S and M have small positive values while R^{Ω} has large positive values. Let ε=Δ_{data}/ΔT=1/h. Set α, ε_{Q}, and α_{Q}, for use in α, ε_{Q}, and α_{Q}.

Assume that the nominal trajectories for price \tilde{x}^{N}(t), risk evolution \tilde{Θ}^{N}(t), and volume ũ^{N}(t) as well as model parameters \hat{p}(t) and data (x^{ask}(t), x^{bid}(t), x^{sell}(t), u^{data}(t), f^{data}(t), and Δ_{data}) are available over the interval [(t_{f}−ΔT)⁺,t_{f}⁻]. Also assume that previously computed input series (e.g. f^{N}(t), φ^{N}(t), and Q^{N}(t)) are also available over the interval [(t_{f}−ΔT)⁺,t_{f}⁻].

Step 1. The CG&S module reads the parameters \hat{p}(t) (A₀, Aᵢ, i=1, . . . ,m, Dⱼ, j=1, . . . ,p, B, and C), at t=t_{f}, from the Parameter Adaptation Engine, and determines if the parameters have changed from the previous iteration. It also computes input series and coefficients and sets the time window for the Repair Generator, i.e., [(t_{f}−ΔT)⁺,t_{f}⁻]. Also, it inputs the data (x^{ask}(t), x^{bid}(t), x^{sell}(t), u^{data}(t), and f^{data}(t)) at time t_{f} from the Asynchronous Filter Bank.
The following input series and coefficients are computed for t=t_{f}:

$${\tilde{u}}^{N} ( {t}_{f} ) = {\tilde{u}}^{N} ( {t}_{f} - {Δ}_{data} )$$

$${f}^{N} ( t ) = {f}^{data} ( t )$$

$$\tilde{A} ( t ) = ( {A}_{0} + {\sum }_{i = 1}^{m} {A}_{i} {\tilde{u}}_{i}^{N} ( t ) + {\sum }_{j = 1}^{p} {D}_{j} {f}_{j}^{N} ( t ) )$$

$$\begin{matrix}{ϕ}^{N} ( t ) = ( {x}^{ sell} ( t ) - {x}^{ sell} ( t - {Δ}_{ data} ) ) - ( {A}_{0} + {\sum }_{i = 1}^{m} {A}_{i} {u}_{i}^{data} ( t ) + \\ {\sum }_{j = 1}^{p} {D}_{j} {f}_{j}^{N} ( t ) ) {x}^{sell} ( t ) - {Bu}^{data} ( t ) - {Cf}^{data} ( t )\end{matrix}$$

$$\begin{matrix}{Q}_{ij}^{N} ( t ) = {ɛ}_{Q}^{2} + {max}_{σ ∈ [ t - Δ T , t ]} \{ \frac{1}{2} ( \sqrt{α } \vert {x}_{i}^{ask} ( σ ) - {x}_{i}^{bid} ( σ ) \vert + \\ {α}_{Q} ) ( \sqrt{α } \vert {x}_{j}^{ask} ( σ ) - {x}_{j}^{bid} ( σ ) \vert + {α}_{Q} ) \}\end{matrix}$$

$$for i , j = 1 , … , n$$

$${g}^{N} ( t ) = \frac{{f}^{N} ( t ) - {f}^{N} ( t - {Δ}_{data} )}{ɛ}$$

$${ξ}^{N} ( t ) = \frac{{ϕ}^{N} ( t ) - {ϕ}^{N} ( t - {Δ}_{data} )}{ɛ}$$

$${W}^{N} ( t ) = \frac{{Q}^{N} ( t ) - {Q}^{N} ( t - {Δ}_{data} )}{ɛ}$$

$${γ}_{y} ( t ) = {\tilde{x}}^{N} ( t ) - {x}^{sell} ( t )$$

$${Θ}_{ii}^{data} ( t ) = {ɛ}_{Q}^{2} + {( \sqrt{α} \vert {x}_{i}^{bid} ( t ) - {x}_{i}^{ask} ( t ) \vert + {α}_{Q} )}^{2} for i = 1 , … , n$$

$${γ}_{Ω} ( t ) = diag ( {\tilde{Θ}}^{N} ( t ) ) - diag ( {Θ}^{data} ( t ) )$$

$${γ}_{v} ( t ) = {\tilde{u}}^{N} ( t ) - {u}^{data} ( t )$$

$$\tilde{B} ( t ) = [ {A}_{1} {\tilde{x}}^{N} ( t ) \vert ⋯ \vert {A}_{m} {\tilde{x}}^{N} ( t ) ] + B$$

$$\tilde{C} ( t ) = {\sum }_{j = 1}^{p} {g}_{j}^{N} ( t ) {D}_{j} {\tilde{x}}^{N} ( t ) + {Cg}^{N} ( t ) + {ξ}^{N} ( t )$$

$${\tilde{V}}_{i} ( t ) = {\tilde{Θ}}^{N} ( t ) {A}_{i}^{T} for i = 1 , … , m$$

$$\tilde{D} ( t ) = {\sum }_{j = 1}^{p} {\tilde{Θ}}^{N} ( t ) {D}_{j}^{T} {g}_{j}^{N} ( t ) + {\sum }_{j = 1}^{p} {D}_{j} {\tilde{Θ}}^{N} ( t ) {g}_{j}^{N} ( t ) + {W}^{N} ( t )$$

Step 2. The Repair Generator uses RSolver to solve the repair optimization model for the repair state y(t), the incremental risk Ω(t), and the repair action v(t) in the time window [t_{f}−ΔT,t_{f}]. Specifically, solve

$${min}_{v} {\int }_{{t}_{f} - Δ T}^{{t}_{f}} δ Π ( y ( t ) , Ω ( t ) , v ( t ) , t ) \text{)} ⅆ t$$

$$subject to$$

$$\frac{ⅆ y ( t )}{ⅆ t} = \tilde{A} ( t ) y ( t ) + \tilde{B} ( t ) v ( t ) + \tilde{C} ( t ) \\ \begin{matrix}\frac{ⅆ Ω ( t )}{ⅆ t} = \tilde{A} ( t ) Ω ( t ) + Ω ( t ) {( \tilde{A} ( t ) )}^{T} - \\ {\tilde{Θ}}^{N} ( t ) {R}^{- 1} Ω ( t ) - Ω ( t ) {R}^{- 1} {\tilde{Θ}}^{N} ( t ) + \\ {\sum }_{i = 1}^{m} {\tilde{V}}_{i} ( t ) {v}_{i} ( t ) + {\sum }_{i = 1}^{m} {( {\tilde{V}}_{i} ( t ) )}^{T} {v}_{i} ( t ) + \tilde{D} ( t )\end{matrix} \\ where \\ \begin{matrix}δ Π ( y ( t ) , Ω ( t ) , v ( t ) , t ) = {( {γ}_{y} ( t ) + ɛ y ( t ) )}^{T} S ( {γ}_{y} ( t ) + ɛy ( t ) ) + \\ {( {γ}_{Ω} ( t ) + diag ( ɛ Ω ( t ) ) )}^{T} {R}^{Ω} ( {γ}_{Ω} ( t ) + \\ diag ( ɛ Ω ( t ) ) ) + {( {γ}_{v} ( t ) + ɛ v ( t ) )}^{T} \\ M ( {γ}_{v} ( t ) + ɛ v ( t ) )\end{matrix}$$

and ε=Δ_{data}/ΔT=1/h, and initial conditions are
y(t_{f}−ΔT)=0
Ω(t_{f}−ΔT)=0.
The Repair Generator updates the new nominal trajectories for tε[(t_{f}−ΔT)⁺,t_{f}⁻] by adding the repair trajectories to the previous nominals,
\tilde{x}^{NN}(t)=\tilde{x}^{N}(t)+εy(t)
\tilde{Θ}^{NN}(t)=\tilde{Θ}^{N}(t)+εΩ(t)
ũ^{NN}(t)=ũ^{N}(t)+εv(t)
Step 3. The CG&S module uses the repaired trajectories to provide initial conditions for price \tilde{x}^{N}(t) and risk evolution \tilde{Θ}^{N}(t) at t=tⱼ,
\tilde{x}^{IC}=\tilde{x}^{NN}(t_{f}⁻)+\tilde{Θ}^{NN}(t_{f}⁻)R⁻¹(x^{sell}(t_{f})−\tilde{x}^{NN}(t_{f}⁻))
\tilde{Θ}^{IC}=\tilde{Θ}^{NN}(t_{f}⁻).
It also calculates \tilde{E}(t_{f}) and Ã^{NN}(t_{f}) using ũ^{NN}(t_{f})),
\tilde{E}(t_{f})=Bũ^{NN}(t_{f})+Cf^{N}(t_{f})+φ^{N}(t_{f})

$${\tilde{A}}^{NN} ( {t}_{f} ) = ( {A}_{0} + {\sum }_{i = 1}^{m} {A}_{i} {\tilde{u}}_{i}^{NN} ( {t}_{f} ) + {\sum }_{j = 1}^{p} {D}_{j} {f}_{j}^{N} ( {t}_{f} ) ) .$$

Note: Add update for Q^{N}(t_{f}).
Step 4. The Nominal Update Generator uses the initial conditions, \tilde{x}^{IC} and \tilde{Θ}^{IC}, and coefficients Ã^{NN}(t_{f}), \tilde{E}(t_{f}), and Q^{N}(t_{f}), from the CG&S module to solve for the nominal price \tilde{x}^{N}(t) and risk \tilde{Θ}^{N}(t) trajectories in the incremental time window tε[t_{f}⁺,(t_{f}+ΔT)⁻]. Specifically, solve

$$\frac{ⅆ {\tilde{x}}^{N} ( t )}{ⅆ t} = {\tilde{A}}^{NN} ( {t}_{f} ) {\tilde{x}}^{N} ( t ) + \tilde{E} ( {t}_{f} )$$

$$\begin{matrix}\frac{ⅆ {\tilde{Θ}}^{N} ( t )}{ⅆ t} = {\tilde{Θ}}^{N} ( t ) {( {\tilde{A}}^{NN} ( {t}_{f} ) )}^{T} + {\tilde{A}}^{NN} ( {t}_{f} ) {\tilde{Θ}}^{N} ( t ) - \\ {\tilde{Θ}}^{N} ( t ) {R}^{- 1} {\tilde{Θ}}^{N} ( t ) + {Q}^{ N} ( {t}_{ f} )\end{matrix}$$

with initial conditions \tilde{x}^{IC} and \tilde{Θ}_{IC}, and the coefficients Ã^{NN}(t_{f}), \tilde{E}(t_{f}), and Q^{N}(t_{f}) are kept constant at time t_{f} throughout the time window.

Output \tilde{x}^{N}(t_{f}+ΔT) and \sqrt{\tilde{Θ}ᵢᵢ^{N}(t_{f}+ΔT)} for i=1, . . . ,n, and save \tilde{x}^{N}(t), \tilde{Θ}^{N}(t), d\tilde{x}^{N}(t)/dt, and d\tilde{Θ}^{N}(t)/dt every Δ_{data} throughout the time window in the database for use in the Parameter Adaptation Engine and the Controller.

Step 5. Update the sliding window
t_{f}←t_{f}+Δ_{data}
and trajectories for tε[(t_{f}−ΔT)⁺,t_{f}⁻]
\tilde{x}^{N}(t)←\tilde{x}^{NN}(t)
\tilde{Θ}^{N}(t)←\tilde{Θ}^{NN}(t)
and for tε[(t_{f}−ΔT)⁺,t_{f}⁻],
ũ^{N}(t)←ũ^{NN}(t)
and go to Step 1.
3.5 Parameter Adaptation Engine
The inputs to the Parameter Adaptation Engine (PAE) are the trajectories generated by the Continuous Forecast Engine. These inputs are the trajectories X=(\tilde{x}^{N}(t), \tilde{Θ}^{N}(t), ũ^{N}(t), f^{N}(t), Q^{N}(t)). The Parameter Adaptation Engine generates periodically updates to estimates of the parameters Pars=(A₀, Aᵢ, i=1, . . . ,m, Dⱼ, j=1, . . . ,p, B, C). The Parameter Adaptation Engine implements an unbiased minimum variance estimator designed by the Clearsight team.

The main idea is to use the following version of Bayes' rule

$$P \text{(} Pars \vert X ) = \frac{P ( X \vert Pars ) P ( Pars )}{P ( X )} .$$

Pars is a stochastic process whose sample paths record conditional estimates of the parameters for the filtration generated by the process X. The Parameter Adaptation Engine generates the first and second moments of the stochastic process defined by (21).

The process Pars is sampled at regular time intervals T. During each interval T the conditional expectation (the first moment) is kept constant in CFE. This is required to satisfy a stability requirement of the overall system (see Kushner [4]).

3.5.1 Observation Model Definition for PAE

In this subsection we derive the observation model for the process Pars. Recall that the conditional first moment of the price process \tilde{x}(t), given a sample of the parameters, is given by (2),

$$\frac{ⅆ \tilde{x} ( t )}{ⅆ t} = ( {A}_{0} + {\sum }_{i = 1}^{m} {A}_{i} {u}_{i} ( t ) + {\sum }_{j = 1}^{p} {D}_{j} {f}_{j} ( t ) ) \tilde{x} ( t ) + Bu ( t ) + Cf ( t ) + ϕ ( t )$$

for an interval tε[t₀,t₁].

The parameters to be estimated are:
A₀ is an n×n matrix,
Aᵢ, i=1, . . . ,n is an n×n matrix of rank one, and we assume that the only non-zero value is the ii^{th} entry, denoted Aᵢ_{ᵢᵢ},
Dⱼ, j=1, . . . ,p is a diagonal n×n matrix,
B is a diagonal n×n matrix, with diagonal elements denoted
Bᵢᵢ for i=1, . . . ,n, and
C is an n×p matrix.
Let η(t) be the observation process

$$η ( t ) = \frac{ⅆ \tilde{x} ( t )}{ⅆ t} - ϕ ( t ) .$$

Then from (22)

$$η ( t ) = ( {A}_{0} + {\sum }_{i = 1}^{m} {A}_{i} {u}_{i} ( t ) + {\sum }_{j = 1}^{p} {D}_{j} {f}_{j} ( t ) ) \tilde{x} ( t ) + Bu ( t ) + Cf ( t ) + \tilde{θ} ( t ) ,$$

where \tilde{θ}(t) is a zero-mean stochastic process with covariance

$${R}_{ij} ( t ) = \{ \begin{matrix}\frac{ {\tilde{Θ}}_{ii} ( t )}{{Δ}_{data}} & if i = j \\ 0 & otherwise\end{matrix}$$

that models the observation error.

We write the observation model for the parameters (23) as
η(t)=\tilde{P}(t)p(t)+\tilde{θ}(t),
where p(t) and \tilde{P}(t) are defined below.

We define a column vector p(t) of dimension q×1, where q=n²+2np+2n as follows:

$$p ( t ) = [ \begin{matrix}{p}_{0} ( t ) \\ {p}_{A} ( t ) \\ {p}_{D} ( t ) \\ {p}_{B} ( t ) \\ {p}_{C} ( t )\end{matrix} ]$$

where each block (p₀(t), p_{A}(t), p_{D}(t), p_{B}(t), p_{C}(t)) of p(t) is described below. The first block p₀(t) is an n²×1 column vector consisting of A₀,

$${p}_{0} ( t ) = [ \begin{matrix}{A}_{{0}_{11}} ( t ) \\ {A}_{{0}_{12}} ( t ) \\ ⋮ \\ \underline{{A}_{{0}_{1 n}} ( t )} \\ {A}_{{0}_{21}} ( t ) \\ {A}_{{0}_{22}} ( t ) \\ ⋮ \\ \underline{{A}_{{0}_{2 n}} ( t )} \\ ⋮ \\ \overline{{A}_{{0}_{n 1}} ( t )} \\ {A}_{{0}_{n 2}} ( t ) \\ ⋮ \\ {A}_{{0}_{nn}} ( t )\end{matrix} ]$$

the second block p_{A}(t) is an n×1 is an n column vector consisting of the nonzero entries of Aᵢ, i=1, . . . ,n,

$${p}_{A} ( t ) = [ \begin{matrix}{A}_{{1}_{11}} ( t ) \\ {A}_{{2}_{22}} ( t ) \\ ⋮ \\ {A}_{{n}_{nn}} ( t )\end{matrix} ]$$

the third block p_{D}(t) is an np×1 column vector consisting of nonzero (diagonal) entries of Dⱼ, j=1, . . . ,p,

$${p}_{D} ( t ) = [ \begin{matrix}{D}_{{1}_{11}} ( t ) \\ {D}_{{1}_{22}} ( t ) \\ ⋮ \\ \underline{{D}_{1 nn} ( t )} \\ {D}_{{2}_{11}} ( t ) \\ {D}_{{2}_{22}} ( t ) \\ ⋮ \\ \underline{{D}_{2 nn} ( t )} \\ ⋮ \\ \overline{{D}_{{p}_{11}} ( t )} \\ {D}_{{p}_{22}} ( t ) \\ ⋮ \\ {D}_{{p}_{nn}} ( t )\end{matrix} ]$$

the fourth block p_{B}(t) is an n×1 column vector consisting of the diagonal elements of B,

$${p}_{B} ( t ) = [ \begin{matrix}{B}_{11} ( t ) \\ {B}_{22} ( t ) \\ ⋮ \\ {B}_{nn} ( t )\end{matrix} ]$$

and the fifth block p_{C}(t) is an np×1 column vector consisting of the elements of matrix C,

$${P}_{C} ( t ) = [ \begin{matrix}{C}_{11} ( t ) \\ {C}_{12} ( t ) \\ ⋮ \\ \underline{{C}_{1 p} ( t )} \\ {C}_{21} ( t ) \\ {C}_{22} ( t ) \\ ⋮ \\ \underline{{C}_{2 p} ( t )} \\ ⋮ \\ \overline{{C}_{n 1} ( t )} \\ {C}_{n 2} ( t ) \\ ⋮ \\ {C}_{np} ( t )\end{matrix} ] .$$

We now provide the structure of \tilde{P}(t), a sparse n×q matrix. We write this matrix in terms of five blocks \tilde{P}₀(t), \tilde{P}_{A}(t), \tilde{P}_{D}(t), \tilde{P}_{B}(t), \tilde{P}_{C}(t):
\tilde{P}(t)=[\tilde{P}₀(t)|\tilde{P}_{A}(t)|\tilde{P}_{D}(t)|\tilde{P}_{B}(t)|\tilde{P}_{C}(t)].
The first block \tilde{P}₀(t) is n×n²,

$${\tilde{P}}_{0} ( t ) = [ \begin{matrix}{\tilde{x}}_{1} ( t ) & {\tilde{x}}_{2} ( t ) & ⋯ & {\tilde{x}}_{n} ( t ) & & & & & & & & & \\ & & & & {\tilde{x}}_{1} ( t ) & {\tilde{x}}_{2} ( t ) & ⋯ & {\tilde{x}}_{n} ( t ) & & & & & \\ & & & & & & & & ⋰ & & & & \\ & & & & & & & & & {\tilde{x}}_{1} ( t ) & {\tilde{x}}_{2} ( t ) & ⋯ & {\tilde{x}}_{n} ( t )\end{matrix} ]$$

the second block \tilde{P}_{A}(t) is n×n,

$${\tilde{P}}_{A} ( t ) = [ \begin{matrix}{\tilde{x}}_{1} ( t ) {u}_{1} ( t ) & & & \\ & {\tilde{x}}_{2} ( t ) {u}_{2} ( t ) & & \\ & & ⋰ & \\ & & & {\tilde{x}}_{n} ( t ) {u}_{n} ( t )\end{matrix} ]$$

the third block \tilde{P}_{D}(t) is n×np,

$${\tilde{P}}_{D} ( t ) = [ \begin{matrix}{\tilde{x}}_{1} ( t ) {f}_{1} ( t ) & & & & {\tilde{x}}_{1} ( t ) {f}_{2} ( t ) & & & & & {\tilde{x}}_{1} ( t ) {f}_{p} ( t ) & & & \\ & {\tilde{x}}_{2} ( t ) {f}_{1} ( t ) & & & & {\tilde{x}}_{2} ( t ) {f}_{2} ( t ) & & & & & {\tilde{x}}_{2} ( t ) {f}_{p} ( t ) & & \\ & & ⋰ & & & & ⋰ & & ⋯ & & & ⋰ & \\ & & & {\tilde{x}}_{n} ( t ) {f}_{1} ( t ) & & & & {\tilde{x}}_{n} ( t ) {f}_{2} ( t ) & & & & & {\tilde{x}}_{n} ( t ) {f}_{p} ( t )\end{matrix} ]$$

the fourth block \tilde{P}_{B}(t) is n×n,

$${\tilde{P}}_{B} ( t ) = [ \begin{matrix}{u}_{1} ( t ) & & & \\ & {u}_{2} ( t ) & & \\ & & ⋰ & \\ & & & {u}_{n} ( t )\end{matrix} ]$$

and the fifth block \tilde{P}_{C}(t) is n×np,

$${\tilde{P}}_{C} ( t ) = [ \begin{matrix}{f}_{1} ( t ) & {f}_{2} ( t ) & ⋯ & {f}_{p} ( t ) & & & & & & & & & \\ & & & & {f}_{1} ( t ) & {f}_{2} ( t ) & ⋯ & {f}_{p} ( t ) & & & & & \\ & & & & & & & & ⋯ & & & & \\ & & & & & & & & & {f}_{1} ( t ) & {f}_{2} ( t ) & ⋯ & {f}_{p} ( t )\end{matrix} ] .$$

3.5.2 Discrete Dynamics for PAE
The Parameter Adaptation Engine generates an estimate of the parameters p at sampled time intervals kΔ_{data}, k=0, 1, 2, . . . . We assume the parameters are time invariant over time-window intervals, therefore the parameter dynamics is given by
p(tₖ₊₁)=p(tₖ)+v(tₖ)
where v(tₖ) is a zero mean Gaussian Brownian q process with covariance \tilde{Q}(tₖ) that models a process noise.

The positive definite matrix \tilde{Q}(tₖ) is a q×q diagonal matrix with the diagonal elements given in equations (26) and (27). The covariance matrix \tilde{Q}(tₖ) is computed by finding the trace of the covariance matrix of the stochastic process p(t)−\hat{p}(t):
Tr(E[(p(t)−\hat{p}(t))(p(t)−\hat{p}(t))^{T}])=Tr(E[p(t)p^{T}(t)−p(t)\hat{p}^{T}(t)−\hat{p}(t)p^{T}(t)+\hat{p}(t)\hat{p}(t)^{T}]).
To approximate the covariance, we update our estimate of \tilde{Q}(tₖ) every length of the time window T, using the last two stored parameter estimates, \hat{p}(t−tmod(T)−T) and the previous \hat{p}(t−tmod(T)−2T) as follows,

$${\tilde{Q}}_{ij} ( 0 ) = \{ \begin{matrix} \frac{{( {α}_{p} )}^{2}}{{Δ}_{data}} Tr ( \hat{p} ( 0 ) {\hat{p}}^{T} ( 0 ) ) & if i = j \\ 0 & otherwise\end{matrix} for i , j = 1 , … , q$$

and when t mod(T)=0,

$${\tilde{Q}}_{ij} ( t ) = \{ \begin{matrix}\begin{matrix} \frac{ {( {α}_{ p} )}^{2}}{ {Δ}_{ data}} \vert {{\sum }^{q}}_{k = 1} {( { \hat{p}}_{k} ( t - T ) )}^{2} - 2 { \hat{p}}_{k} ( t - T ) { \hat{p}}_{k} ( t - 2 T ) + \\ {( {\hat{p}}_{k} ( t - T ) )}^{2} \vert\end{matrix} & if i = j \\ 0 & otherwise\end{matrix}$$

for i, j=1, . . . ,q, and when t mod(T)≠0, let \tilde{Q}ᵢⱼ(t)=\tilde{Q}ᵢⱼ(t−tmod(T)). We let αₚ=0.05 initially. Notice that while \tilde{Q}(t) is a q×q matrix, it is diagonal and all the diagonal elements have the same value, so it is only necessary to store a single value to represent \tilde{Q}(t).
3.5.3 Estimation Method for \tilde{Q}(t) in PAE
The stochastic equation for parameters is
dp(t)=0+dv(t)
where dv(t) is a zero mean Gaussian Brownian process with covariance \tilde{Q}(t)dt, and \tilde{Q}(t) is positive definite.

In the forecast engine, we use discrete Kalman filter to update parameters p(t). Given the k^{th} estimation of parameters, \tilde{p}ₖ and its covariance Σ_{k|k} and given (k+1)^{th} observation \tilde{R} and given \tilde{p}, we update Σ to get
Σ_{k+1|k+1}=(Σ_{k|k}+\tilde{Q})−(Σ_{k|k}+\tilde{Q})\tilde{p}^{T}(Σ_{k|k}+\tilde{Q})\tilde{p}^{T}+\tilde{R})⁻¹\tilde{p}(Σ_{k|k}+\tilde{Q})
where \tilde{R} and \tilde{Q} are diagonal. If k→∞, then Σₖ→stable states, which are denoted by Σ_{∞}. Therefore as k→∞, then Σ_{k|k}→Σ_{∞}, Σ_{k+1|k+1}→Σ_{∞}, and \tilde{Q}→\tilde{Q}_{∞}. Restating equation (28) using Σ_{∞} and \tilde{Q}_{∞} we get
Σ_{∞}=(Σ_{∞}+\tilde{Q}_{∞})−(Σ_{∞}+\tilde{Q}_{∞})\tilde{p}^{T}(\tilde{p}(Σ_{∞}+\tilde{Q}_{∞})\tilde{p}^{T}+\tilde{R})⁻¹\tilde{p}(Σ_{∞}+\tilde{Q}_{∞})

We assume that the parameters are independent in infinity (i.e. Σ_{∞} is diagonal), and that the main contribution of \tilde{p} to Σ_{∞} (i, i) is the i^{th} column of \tilde{p}, and that other columns can be ignored. Let

$${\sum }_{i}^{∞}$$

denote Σ_{∞}(i, i), \tilde{Q}ᵢ^{∞} denote \tilde{Q}_{∞}(i, i), \tilde{p}ᵢ denote the i^{th} column of \tilde{p}. Also assume that for the scaler r,

$${\tilde{Q}}_{i}^{∞} = \{ \begin{matrix}r & \begin{matrix} if {p}_{ i} is the parameter related to u ( t ) or \\ x ( t ) or f ( t ) terms\end{matrix} \\ {r}^{2} & \begin{matrix}if {p}_{ i} is the parameter associated with \\ x ( t ) v ( t ) or x ( t ) f ( t ) terms\end{matrix}\end{matrix}$$

Then we can restate equation (28) again as

$$\begin{matrix}{\sum }_{i}^{∞} = ( {\sum }_{i}^{∞} + {\tilde{Q}}_{i}^{∞} ) - ( {\sum }_{i}^{∞} + {\tilde{Q}}_{i}^{∞} ) {{\tilde{p}}_{i}^{T} ( {\tilde{p}}_{i} ( {\sum }_{i}^{∞} + {\tilde{Q}}_{i}^{∞} ) {\tilde{p}}_{i}^{T} + \tilde{R} )}^{- 1} \\ {\tilde{p}}_{i} ( {\sum }_{i}^{∞} + {\tilde{Q}}_{i}^{∞} ) .\end{matrix}$$

Let n denote the number of correlated stocks. The structure of \tilde{p}ᵢ is n×1, and only one entry is non-zero, which we denote by j. Then

$$\begin{matrix}{{\tilde{p}}_{i}^{T} ( {\tilde{p}}_{i} ( {\sum }_{i}^{∞} + {\tilde{Q}}_{i}^{∞} ) {\tilde{p}}_{i}^{T} + \tilde{R} )}^{- 1} {\tilde{p}}_{i} = {\tilde{p}}_{i} ( j ) \text{(} {\tilde{p}}_{i} ( j ) ( {\sum }_{i}^{∞} + {\tilde{Q}}_{i}^{∞} ) {\tilde{p}}_{i} ( j ) + \\ { \tilde{R} ( j , j ) )}^{- 1} {\tilde{p}}_{i} ( j ) \\ = {[ {\tilde{p}}_{i} ( j ) ]}^{2} \text{(} {\tilde{p}}_{i} ( j ) ( {\sum }_{i}^{∞} + {\tilde{Q}}_{i}^{∞} ) {\tilde{p}}_{i} ( j ) + \\ { \tilde{R} ( j , j ) )}^{- 1}\end{matrix}$$

Let αᵢ=(\tilde{p}ᵢ(j))², where j is index of the only non-zero entry of \tilde{p}ᵢ, and noting that \tilde{R} is an n×n diagonal matrix, then

$$\begin{matrix}{\sum }_{i}^{∞} = ( {\sum }_{i}^{∞} + {\tilde{Q}}_{i}^{∞} ) - ( {\sum }_{i}^{∞} + {\tilde{Q}}_{i}^{∞} ) {α}_{i} ( {α}_{i} ( {\sum }_{i}^{∞} + {\tilde{Q}}_{i}^{∞} ) {\tilde{p}}_{i}^{T} + \\ { \tilde{R} ( j , j ) )}^{- 1} ( {\sum }_{i}^{∞} + {\tilde{Q}}_{i}^{∞} )\end{matrix}$$

$$\begin{matrix}{α}_{i} ( {\sum }_{i}^{∞} + {\tilde{Q}}_{i}^{∞} ) {\sum }_{i}^{∞} + \tilde{R} ( j , j ) {\sum }_{i}^{∞} = {{α}_{i} ( {\sum }_{i}^{∞} + {\tilde{Q}}_{i}^{∞} )}^{2} + ( {\sum }_{i}^{∞} + {\tilde{Q}}_{i}^{∞} ) \tilde{R} ( j , j ) - \\ {{α}_{i} ( {\sum }_{i}^{∞} + {\tilde{Q}}_{i}^{∞} )}^{2}\end{matrix}$$

$${{α}_{i} ( {\sum }_{i}^{∞} )}^{2} + {α}_{i} {\tilde{Q}}_{i}^{∞} {\sum }_{i}^{∞} - {\tilde{Q}}_{i}^{∞} \tilde{R} ( j , j ) = 0$$

which is solved for

$${\sum }_{i}^{∞}$$

$${\sum }_{i}^{∞} = \frac{- {α}_{i} {\tilde{Q}}_{i}^{∞} \pm \sqrt{{( {α}_{i} {\tilde{Q}}_{i}^{∞} )}^{2} + 4 {\tilde{Q}}_{i}^{∞} \tilde{R} ( j , j )}}{2 {α}_{i}} .$$

Because Σᵢ^{∞}≧0 we use only the “+” which gives us

$${\sum }_{i}^{∞} = \frac{- {α}_{i} {\tilde{Q}}_{i}^{∞} + \sqrt{{( {α}_{i} {\tilde{Q}}_{i}^{∞} )}^{2} + 4 {\tilde{Q}}_{i}^{∞} \tilde{R} ( j , j )}}{2 {α}_{i}} .$$

where j corresponds to the one and only non-zero entry of \tilde{p}ᵢ.

In the algorithm, \tilde{Q}ᵢ^{∞} will be estimated by

$${\sum }_{i}^{∞} ,$$

i.e.

$${\tilde{Q}}_{i}^{∞} = [ \begin{matrix}{\sum }_{1}^{∞} & 0 & ⋯ & 0 \\ 0 & {\sum }_{2}^{∞} & ⋯ & 0 \\ ⋮ & ⋮ & ⋰ & ⋮ \\ 0 & 0 & ⋯ & {\sum }_{q}^{∞}\end{matrix} ]$$

where q is the number of parameters; αᵢ and \tilde{Q}ᵢ^{∞} are as we defined above; and R and \tilde{p}ᵢ are given functions of time.
3.5.4 Aggregated Discrete Observation Model for PAE
To ensure sufficient statistics well-posediness, we need to construct an observation sample out of the observations generated during the interval ΔT. The number of needed observations in the observation sample is a function of the number of parameters to be identified, q.

The discrete observation model is given by
π(tₖ)=\tilde{P}(tₖ)p(tₖ)+\tilde{θ}(tₖ)
where \tilde{θ}(tₖ) is a zero mean discrete Gaussian stochastic measurement noise with covariance \tilde{R}(tₖ) and π(tₖ) and \tilde{P}(tₖ) are defined later. The covariance matrix \tilde{R}(tₖ) is an

$$( n \frac{Δ T}{{Δ}_{data}} ) \times ( n \frac{Δ T}{{Δ}_{data}} )$$

diagonal matrix given by

$$\tilde{R} ( {t}_{k} ) = [ \begin{matrix}R ( {t}_{k} ) & & & \\ & R ( {t}_{k} - {Δ }_{data} ) & & \\ & & ⋰ & \\ & & & R ( {t}_{k} - Δ T + {Δ }_{data} )\end{matrix} ]$$

where

$${R}_{ij} ( {t}_{k} ) = \{ \begin{matrix}\frac{{\tilde{Θ}}_{ii} ( {t}_{k} )}{{Δ}_{data}} & if i = j \\ 0 & otherwise\end{matrix}$$

for i, j=1, . . . ,n.

Now we define π(tₖ) and \tilde{P}(tₖ). The column vector π(tₖ) is

$$n ( \frac{Δ T}{{Δ}_{data}} ) ⨯ 1 ,$$

$$Π ( {t}_{k} ) = [ \begin{matrix}η ( {t}_{k} ) \\ η ( {t}_{k} - {Δ}_{data} ) \\ η ( {t}_{k} - 2 {Δ}_{data} ) \\ ⋮ \\ η ( {t}_{k} - Δ T + {Δ}_{data} )\end{matrix} ]$$

and each η(t) block is n×1 with

$$η ( t ) = \frac{ⅆ \tilde{x} ( t )}{ⅆ t} - ϕ ( t ) .$$

The matrix

$$\tilde{\tilde{P}} ( {t}_{k} ) is ( n \frac{Δ T}{{Δ}_{data}} ) ⨯ q ,$$

$$\tilde{\tilde{P}} ( {t}_{k} ) = [ \begin{matrix}\tilde{P} ( {t}_{k} ) \\ \tilde{P} ( {t}_{k} - {Δ}_{data} ) \\ \tilde{P} ( {t}_{k} - 2 {Δ}_{data} ) \\ ⋮ \\ \tilde{P} ( {t}_{k} - Δ T + {Δ}_{data} )\end{matrix} ]$$

and each \tilde{P}(t) block is n×q and given in (24).
3.5.5 Discrete Filter
We now describe our implementation of the discrete filter. Let \hat{p}(tₖ₊₁|tₖ) denote an estimate (conditional mean) of p(t) at time sample tₖ₊₁ given observations up to time tₖ, and let \hat{p}(tₖ₊₁|tₖ₊₁) denote an estimate f p(t) at time sample tₖ₊₁ given an observation at time tₖ₊₁. Let also Σ(tₖ₊₁|tₖ) denote the covariance matrix of p(t) at time sample tₖ₊₁.

Let K_{D}(tₖ₊₁) be a

$$q ⨯ ( n \frac{Δ T }{{Δ}_{data}} )$$

matrix representing the discrete gain at time sample tₖ₊₁. It is given by (see Jazwinski [3]),

$${K}_{D} ( {t}_{k + 1} ) = \sum ( {t}_{k + 1} \text{\vert} {t}_{k} ) {( \tilde{\tilde{P}} ( {t}_{k + 1} ) )}^{T} {( \tilde{\tilde{P}} ( {t}_{k + 1} ) \sum ( {t}_{k + 1} \text{\vert} {t}_{k} ) {( \tilde{\tilde{P}} ( {t}_{k + 1} ) )}^{T} + \tilde{R} ( {t}_{k + 1} ) )}^{- 1}$$

The propagation of the conditional mean \hat{p}(tₖ₊₁|tₖ₊₁) and the covariance matrix Σ(tₖ₊₁|tₖ₊₁) after an observation at time tₖ₊₁ is made is given by the following equations
Σ(tₖ₊₁|tₖ)=Σ(tₖ|tₖ)+\tilde{Q}(tₖ₊₁)
Σ(tₖ₊₁|tₖ₊₁)=Σ(tₖ₊₁|tₖ)−K_{D}(tₖ₊₁)\tilde{\tilde{P}}(tₖ₊₁)Σ(tₖ₊₁|tₖ)
\hat{p}(tₖ₊₁|tₖ)=I\hat{p}(tₖ|tₖ)
\hat{p}(tₖ₊₁|tₖ₊₁)=\hat{p}(tₖ₊₁|tₖ)+K_{D}(tₖ₊₁)(π(tₖ₊₁)−\tilde{\tilde{P}}(tₖ₊₁)\hat{p}(tₖ₊₁|tₖ)).

Equation (34) is called a prediction equation because it gives a way to propagate \hat{p}(tₖ|tₖ) without an observation. Equation (35) is called a correction equations because it corrects \hat{p}(tₖ₊₁|tₖ) based on an observation made at time tₖ₊₁. The term (π(tₖ₊₁)−\tilde{\tilde{P}}(tₖ₊₁)\hat{p}(tₖ₊₁|tₖ)), called an innovation process, gives a difference between an observation made at time tₖ₊₁, π(tₖ₊₁), and a “predicted observation” \tilde{\tilde{P}}(tₖ₊₁)\hat{p}(tₖ₊₁|tₖ).

To summarize, we can give the steps needed in the flowchart of PAE.

Step 0. Initialize \hat{p}(0|0) and Σ(0|0). Set current time to tₖ←t₀.

Step 1. Set current time to tₖ←tₖ+ΔT. Get information needed from the shared memory system: \tilde{x}^{N}(t), η(t), tε[tₖ−ΔT+Δ_{data},tₖ]; ũ^{NN}(tₖ−Δ^{T}), f^{data}(tₖ−ΔT).

Step 2. Construct π(tₖ), \tilde{\tilde{P}}(tₖ), \tilde{R}(tₖ), and \tilde{Q}(tₖ)

Step 3 Calculate.
Σ(tₖ|tₖ−ΔT)←Σ(tₖ−ΔT|tₖ−ΔT)+\tilde{Q}(tₖ)

$$\sum ( {t}_{k} \text{\vert} {t}_{k} - Δ T ) ← \frac{1}{2} ( \sum ( {t}_{k} \text{\vert} {t}_{k} - Δ T ) + \sum {( {t}_{k} \text{\vert} {t}_{k} - Δ T )}^{T} )$$

K_{D}(tₖ)←Σ(tₖ|tₖ−ΔT)(\tilde{\tilde{P}}(tₖ))^{T}(\tilde{\tilde{P}}(tₖ)Σ(tₖ|tₖ−ΔT)(\tilde{\tilde{P}}(tₖ))^{T}+\tilde{R}(tₖ))⁻¹
\hat{p}(tₖ|tₖ)←\hat{p}(tₖ−ΔT|tₖ−ΔT)+K_{D}(tₖ)(π(tₖ)−\tilde{\tilde{P}}(tₖ)\hat{p}(tₖ−ΔT|tₖ−ΔT))
Σ(tₖ|tₖ)←(I−K_{D}(tₖ)\tilde{\tilde{P}}(tₖ))Σ(tₖ|tₖ−ΔT)
Σ(tₖ)←(Σ(tₖ)+(Σ(tₖ))^{T})/2
Step 4. Go to Step 1.
3.5.6 Continuous Measurement Filter for PAE
This is cut-and-paste from the previous version of PAE, where we did not have enough data to estimate the parameters.

To conclude, given continuous trajectories x(t), u(t), f(t), and φ(t), the continuous measurement process for p(t) is written as
d\tilde{x}(t)−φ(t)dt=\tilde{P}(t)p(t)dt+dθ(t)
where dθ(t) is a zero mean Gaussian stochastic measurement noise with covariance R(t)dt. The noise θ(t) is due to the noise in measuring price. The covariance matrix R(t) is estimated by the risk \tilde{Θ}(t) where

$${R}_{ij} ( t ) = \{ \begin{matrix}\frac{{\tilde{Θ}}_{ii} ( t )}{{Δ}_{data}} & if i = j \\ 0 & otherwise\end{matrix}$$

for i, j=1, . . . ,n and Δ_{data} is the time step in the Continuous Forecast Engine (possibly one second).

Assuming the parameters are constant over short intervals, we specify the dynamics of the parameter system by the following stochastic differential equation
dp(t)=0+dv(t)
where the 0_{q×1} column vector indicates that \hat{p}(t) is constant over the interval of interest, and dv(t) is a zero mean Gaussian Brownian q process with covariance \tilde{Q}(t)dt, where \tilde{Q}(t) is positive definite. The noise v(t) is due to the noise in the parameters.
The covariance matrix \tilde{Q}(t) is estimated by taking the
Tr(E[(p(t)−\hat{p}(t))(p(t)−\hat{p}(t))^{T}])=Tr(E[p(t)p^{T}(t)−p(t)\hat{p}^{T}(t)−\hat{p}(t)p^{T}(t)+\hat{p}(t)\hat{p}(t)^{T}]).
To approximate the covariance, we update our estimate of \tilde{Q}(t) every length of the time window T, using the last two stored parameter estimates, \hat{p}(t−t mod(T)−T) and the previous \hat{p}(t−t mod(T)−2T) as follows,

$${\tilde{Q}}_{ij} = \{ \begin{matrix}\frac{{( {α}_{p} )}^{2}}{{Δ}_{data}} Tr ( \hat{p} ( 0 ) {\hat{p}}^{T} ( 0 ) ) & if i = j \\ 0 & otherwise\end{matrix} for i , j = 1 , … , q$$

and when t mod(T)=0,

$${\tilde{Q}}_{ij} ( t ) = \{ \begin{matrix}\frac{{( {α}_{p} )}^{2}}{{Δ}_{data}} \vert {\sum }_{k = 1}^{q} {( {\hat{p}}_{k} ( t - T ) )}^{2} - 2 {\hat{p}}_{k} ( t - T ) {\hat{p}}_{k} ( t - 2 T ) + {( {\hat{p}}_{k} ( t - 2 T ) )}^{2} \vert & if i = j \\ 0 & otherwise\end{matrix}$$

for i, j=1, . . . ,q, and when t mod(T)≠0, let \tilde{Q}ᵢⱼ(t)=\tilde{Q}ᵢⱼ(t−t mod(T)). We let αₚ=0.05 initially. Notice that while \tilde{Q}(t) is a q×q matrix, it is diagonal and all the diagonal elements are the same value, so it is only necessary to store a single value to represent \tilde{Q}(t).

We now apply the continuous measurement filter as described in Hybrid Asynchronous Filter. We propagate the conditional mean \hat{p}(τ|tₖ) and covariance matrix Σ(τ|tₖ) according to the following equations,

$$\frac{ⅆ \hat{p} ( τ \text{\vert} {t}_{k} )}{ⅆ τ} = 0 + {K}_{c} ( τ \text{\vert} {t}_{k} ) ( \frac{ⅆ \hat{x} ( τ )}{ⅆ τ} - ϕ ( τ ) - \tilde{P} ( τ ) \hat{p} ( τ \text{\vert} {t}_{k} ) )$$

with initial conditions Σ(tₖ|tₖ), and where K_{c}(τ|tₖ), a q×n matrix, is the continuous gain given by
K_{c}(τ|tₖ)=Σ(τ|tₖ)(\tilde{P}(τ))^{T}(R(τ))⁻¹
and

$$\frac{ⅆ Σ ( τ \text{\vert} {t}_{k} )}{ⅆ τ} = \tilde{Q} ( τ ) - Σ ( τ \text{\vert} {t}_{k} ) {( \tilde{P} ( τ ) )}^{T} {( R ( τ ) )}^{- 1} \tilde{P} ( τ ) Σ ( τ \text{\vert} {t}_{k} )$$

with initial condition Σ(tₖ|tₖ). Note Σ(τ|tₖ) is a q×q symmetric matrix. In the implementation of PAE, the observations d\tilde{x}(τ)/dr, φ(τ), \tilde{P}(τ), and R(τ) are updated every Δ_{data} and \tilde{Q}(τ) is updated every T.
For initialization purposes, an initial \hat{p}(0)=\hat{p}₀ is estimated from historical data using a min least squares approach.
3.6 Learning Engine
The concept of the repair strategy is to first use historical data to estimate the parameters of the model. This is called the training mode. Once we have initial estimates for the parameters, we are in the simulated real-time mode. In this mode, we can use the dynamical model (??) with the estimated parameters to solve for the price and risk trajectories. The time window is advanced and the data is updated. Then the parameters are estimated again. As the time window slides, the repair strategy continuously solves for the price and risk trajectories while updating the parameters in real-time, see section 3.4.
3.7 Lowpass Filter
The Lowpass Filter is used to filter the predicted price \hat{x}^{predict}(t) provided by the Forecast Engine to produce x^{out}(t), the price provided to the user. It does this using a Laplace transform of the signals: \hat{X}^{out}(t) is the Laplace transform of \hat{x}ₒᵤₜ(t).

$$\frac{output signal}{input signal} = \frac{{\hat{x}}_{ℒ}^{out} ( t )}{{\hat{x}}_{ℒ}^{predict} ( t )} = \frac{2 π}{{T}_{LF}} \cdot \frac{1}{t + \frac{2 π}{{T}_{LF}}}$$

T_{LF} is given; a large value of T_{LF} filters high frequency signals.

$$= t \cdot {\hat{x}}^{out} ( t ) + {\hat{x}}^{out} ( t ) \cdot \frac{2 π}{{T}_{LF}} \cdot = \frac{2 π}{{T}_{LF}} {\hat{x}}_{L}^{predict} ( t )$$

Using known properties of Laplace transforms, use inverse Laplace transform [symbol] ⁻¹, where: [symbol]
⁻¹(t·x^{out}(t)=\dot{x}^{out}(t) [symbol]
⁻¹(x^{out}(t))=x^{out}(t) [symbol]
⁻(\hat{x}^{predict}(t))=\hat{x}^{predict}(t)
we have:

$${\dot{x}}^{out} ( t ) = \frac{2 π}{{T}_{LF}} ( {\hat{x}}^{predict} ( t ) - {x}^{out} ( t ) )$$

For each stock, given \hat{x}^{predict}(t_{c}+ΔT) and x^{out}(t_{c}+ΔT−Δ_{c}), which is from the previous filtered forecast, we solve for x^{out}(t_{c}+ΔT). For tε[t_{c}+ΔT−Δ_{c}, t_{c}+ΔT] let \hat{x}^{predict}(t)=constant=\hat{x}^{predict}(t_{c}+ΔT) We solve the following differential equations

$$\frac{ⅆ {x}^{out} ( t )}{ⅆ t} = \frac{2 π}{{T}_{LF}} ( {\hat{x}}^{predict} ( {t}_{c} + Δ T ) - {x}^{out} ( t ) )$$

with the initial condition x^{out}(t_{c}+ΔT−Δ_{c})

If x is a scalar, and x(t)=αx(t)+b for tε[t₀,t₁], then

$$x ( t ) = {ⅇ}^{a ( t - {t}_{0} )} x ( t ) + {\int }_{{t}_{0}}^{t} {ⅇ}^{a ( t - {t}_{0} )} b ⅆ t$$

$${\dot{x}}^{out} ( t ) = \frac{2 π}{{T}_{LF}} ( {x}^{out} ( t ) + \frac{2 π}{{T}_{LF}} {\hat{x}}^{predict} ( {t}_{c} + Δ T )$$

with tε[t_{c}+ΔT−Δ_{c}, t_{c}+ΔT]
Let t₀=t_{c}+ΔT−Δ_{c}, then

$$\begin{matrix}{x}^{out} ( t ) = {ⅇ}^{- \frac{2 π}{{T}_{LF}} ( t - {t}_{0} )} {x}^{out} ( {t}_{0} ) + {\int }_{{t}_{0}}^{t} {ⅇ}^{- \frac{2 π}{{T}_{LF}} ( t - {t}_{0} )} \frac{2 π}{{T}_{LF}} {\hat{x}}^{predict} ( {t}_{c} + Δ T ) ⅆ t \\ = {ⅇ}^{- \frac{2 π}{{T}_{LF}} ( t - {t}_{0} )} {x}^{out} ( {t}_{0} ) - {( {ⅇ}^{- \frac{2 π}{{T}_{LF}} ( t - {t}_{0} )} \frac{2 π}{{T}_{LF}} {\hat{x}}^{predict} ( {t}_{c} + Δ T ) \vert}_{{t}_{0}}^{t} \\ = {ⅇ}^{- \frac{2 π}{{T}_{LF}} ( t - {t}_{0} )} {x}^{out} ( {t}_{0} ) - [ {ⅇ}^{- \frac{2 π}{{T}_{LF}} ( t - {t}_{0} )} - 1 ] {\hat{x}}^{predict} ( {t}_{c} + Δ T ) \\ = {ⅇ}^{- \frac{2 π}{{T}_{LF}} {Δ}_{data}} {x}^{out} ( {t}_{0} ) - {\hat{x}}^{predict} ( {t}_{c} + Δ T ) [ {ⅇ}^{- \frac{2 π}{{T}_{LF}} {Δ}_{data}} - 1 ]\end{matrix}$$

3.8 Implementation
An overview of the modules in the repair system simulated real-time architecture is included below. In this section and in the flowcharts, we assume that computation is instantaneous, so the clock is not advanced during computation.
3.8.1 Asynchronous Filter Bank (AFB)
Reads asynchronous data from the tape, filters it, then sends filtered data at every Δ_{data} to the database.
Input: From the data tape when data is available at time t_{data};
   x^{ask}(t_{data}),x^{bid}(t_{data}),x^{sell}(t_{data}),u^{data}(t_{data}),f^{data}(t_{data})
Output: To the database for t every Δ_{data};
   x^{ask}(t),x^{bid}(t),x^{sell}(t),u^{data}(t),f^{data}(t)
   3.8.2 Parameter Adaptation Engine (PAE)
Computes the \hat{p}(t_{c}) parameters including {A₀, Aᵢ, i=1, . . . ,n, Dⱼ, j=1, . . . ,p, B, C}.
Input: From the database for nominal trajectories at time l=t_{c}−T;
\tilde{x}^{N}(l),\tilde{Θ}^{N}(l),ũ^{N}(l),f^{N}(l),
and for time t_{c};

$$\frac{ⅆ {\tilde{x}}^{N} ( t )}{ⅆ t} {\vert}_{{t}_{c}} , {ϕ}^{N} ( {t}_{c} )$$
Output: To the database when t_{c} mod T=0; \hat{p}(t_{c}),
   or if \hat{p}(ξ) was updated for t_{c}−Δ_{data}<ξ≦t_{c}, and ξ mod T=0, then store \hat{p}(ξ)
   3.8.3 Continuous Forecast Engine (CFE)
   Computes nominal and repair trajectories. Consists of the following elements: Initialization CFE Routine, Coefficient Generator and Synchronization module, Repair Generator and Nominal Update Generator.
   CFE: Initialization CFE Routine
Computes an initial estimate of p, and the following data:
   \tilde{x}^{IC}(t_{c}),\tilde{x}^{N}(t_{c}),\tilde{Θ}^{IC}(t_{c}),\tilde{Θ}^{N}(t_{c}),Q^{N}(t_{c}),ũ^{NN}(t_{c}),f^{N}(t_{c}), φ^{N}(t_{c}),g^{N}(t_{c}),ξ^{N}(t_{c}),W^{N}(t_{c})
   CFE: Nominal Update Generator
Computes a forecast of the price and the risk value at t_{c}+ΔT.
Input:
   \tilde{x}^{IC}(t_{c}),\tilde{Θ}^{IC}(t_{c}),Ã^{NN}(t_{c}),\tilde{E}^{NN}(t_{c}),Q^{N}(t_{c})
Output: To user \tilde{x}ᵢ^{N}(t_{c}+ΔT), and \sqrt{\tilde{Θ}ᵢᵢ^{N}(t_{c}+ΔT)} for each stock i=1, . . . ,n and sends to the database, \tilde{x}^{N}(τ), (\tilde{Θ}^{N}(τ), d\tilde{x}^{N}/dt|_{τ} for t_{c}≦τ≦t_{c}+ΔT
CFE: Coefficient Generator and Synchronization (CG&S)
Computes the coefficients needed for the Repair Generator and the Nominal Update Generator, and also identifies whether the parameters have changed and sets t₁,

$${t}_{1} = \{ \begin{matrix}{t}_{c} - T + Δ T if {t}_{c} = 0 mod T \\ {t}_{c} if {t}_{c} \neq 0 mod T\end{matrix}$$

where
Input:
   \hat{p}(t_{c}),Q^{N}(t_{c}),x^{sell}(t_{c}),
   \tilde{x}^{N}(t),\tilde{Θ}^{N}(t),ũ^{N}(t),f^{N}(t),g^{N}(t),φ^{N}(t),ξ^{N}(t),W^{N}(t) for t=t₁, t₁+Δ_{data}, . . . ,t_{c}
   x^{ask}(t),x^{bid}(t),t=t_{c}−ΔT+Δ_{data},t_{c}−ΔT+2Δ_{data},t_{c}
Output:
   Coefficients output to CFE for use in the Repair Generator and in the Nominal Update Generator include:
   Ã(t),\tilde{B}(t),\tilde{C}(t),\tilde{D}(t),\tilde{V}(t),γ_{y}(t),γ_{Ω}(t),γᵥ(t),for t=t₁,t₁+Δ_{data}, . . . ,t_{c}+ΔT
   x^{sell}(t_{c}+ΔT),Q^{N}(t_{c}+ΔT)
   Nominal trajectories stored in the database include:
   ũ^{N}(t),f^{N}(t), φ^{N}(t),g^{N}(t),ξ^{N}(t),W^{N}(t),x^{ask}(t),x^{bid}(t) for t=t_{c}+Δ_{data},t_{c}+2Δ_{data}, . . . ,t_{c}+ΔT
   CFE: Repair Generator
   Uses the coefficients prepared by CG&S to solve the repair problem (using RSolver or other solver) for the repair variables over [t₁,t_{c}], which is considered long repair if parameters have changed and t₁=t_{c}−T+ΔT, or short repair if parameters have not changed and t₁=t_{c}. Also computes observations η needed for PAE.
Input:
   Ã(t),\tilde{B}(t),\tilde{C}(t),\tilde{D}(t),\tilde{E}(t),\tilde{V}(t),γ_{y}(t),γ_{Ω}(t),γᵥ(t),\tilde{x}^{N}(t),\tilde{Θ}^{N}(t),ũ^{N}(t) for t=t₁,t₁+Δ_{data}, . . . ,t_{c}+ΔT
   \tilde{x}^{N}(t),\tilde{Θ}^{N}(t),ũ^{N}(t),f^{N}(t) for t=t_{c}−ΔT+Δ_{data},t_{c}−ΔT+2Δ_{data}, . . . ,t_{c}
Output:
   To CFE: \tilde{x}^{NN}(t_{c}), \tilde{Θ}^{NN}(t_{c})
   To Shared Memory System:
   R(t),η(t) for t=t_{c}−ΔT+Δ_{data},t_{c}−ΔT+2Δ_{data}, . . . ,t_{c}, and ũ^{NN}(t_{c}),f^{N}(t_{c})

1. A method for generating a real time state forecast signal for a financial instrument, the method comprising:
receiving information about a market instrument;
transforming the received market-instrument information into a synchronous signal;
estimating uncertainty in the market-instrument information;
estimating parameters of a model characterizing the instrument dynamics; and
determining a nominal state forecast signal for the financial instrument.

2. The method of claim 1 wherein financial instruments include:
currency;
stocks;
bonds; and
futures

3. The method of claim 1 wherein a state forecast signal may include one or more of:
a price signal;
a risk signal;
a volatility signal;
a marginal volume signal;
a price-rate signal;
a risk-rate signal;
a volatility-rate signal; and
a marginal-volume-rate signal.
